(19) United States
(12) Patent Application Publication
(10) Pub. No.: US 2024/0375918 A1
(43) Pub. Date: Nov. 14, 2024

(54) CRANE WITH DERRICK BALLAST

(71) Applicant: Liebherr-Werk Ehingen GmbH, Ehingen (DE)

(72) Inventors: Clemens NORZ, Ehingen (DE); Engelbert HÄBE, Ehingen (DE); Matthias KLEY, Ehingen (DE); Marcus JECHLE, Ulm (DE); Hans-Joachim WENGER, Ehingen (DE); Matthias STROEBELE, Oggelsbeuren (DE); Leonie DIESCH, Ehingen OT Mühlen (DE)

(21) Appl. No.: 18/661,121

(22) Filed: May 10, 2024

(30) Foreign Application Priority Data
May 11, 2023 (DE) 10 2023 112 413.7

(51) Int. Cl. B66C 23/76; B66C 13/50; B66C 23/88

(52) U.S. Cl. CPC B66C 23/76; B66C 13/50; B66C 23/88; B66C 2700/0371

(57) ABSTRACT

The invention relates to a crane comprising a movable undercarriage, a superstructure mounted rotatably on the undercarriage, a boom connected to the superstructure in a luffable manner, a derrick boom connected to the superstructure in an articulated manner, via which the boom is braced, a crane control system, a guide connected to the superstructure, and a derrick ballast. The derrick ballast comprises a ballast plate for stacking ballast elements, which is connected to the derrick boom via the ballast bracing and to the superstructure via the guide, as well as a ballast wagon. The ballast wagon comprises a standard heavy-load transport device with its own drive and drive control. According to the invention, the guide is connected to the ballast plate or the ballast wagon via a connection device which comprises a measuring device and is configured to detect a force which counteracts a relative movement between the ballast wagon and the guide. According to the invention, the crane control is connected to the drive control of the heavy-load transport device via a control connection and is configured to control and/or regulate the heavy-load transport device depending on the force detected by the measuring device.

### TECHNICAL FIELD

The present invention relates to a crane.

### BACKGROUND

Derrick cranes typically comprise a crawler chassis. Due to the additional derrick ballast, these cranes are configured to lift and move particularly heavy loads. On these cranes, the main boom (hereinafter referred to as the “boom”—typically a lattice boom) and the derrick boom are connected to each other via an adjustable cable bracing system. The derrick boom is connected to the rear end of the superstructure or rear of the superstructure via a length-adjustable derrick bracing. By adjusting (i.e. lengthening or shortening) the derrick bracing, the inclination of the derrick boom relative to the superstructure can be set. During crane operation, the angle of the derrick boom is usually unchanged. The luffing movement of the main boom takes place via the adjustment of the luffing cable system between the boom and derrick boom.

### SUMMARY

The moment that the boom applies into the boom system with the load it is carrying must therefore be absorbed by the derrick boom. In addition, the overall “crane” system must remain stable. This means that the overall center of gravity must be located within the tilting edges. When lifting heavy loads, this is not possible with a superstructure ballast alone. For this reason, the derrick ballast is required as an additional ballast. This is connected to the free end of the derrick boom via a variable-length ballast bracing. The length of the ballast bracing can be adjusted using hydraulic pull cylinders, for example.

Derrick ballasts in the form of a suspended ballast or a ballast wagon that can be moved on the floor with ballast elements stacked on it are known from the prior art. A suspended ballast can generally adopt two operating modes: it can be set down on the floor or suspended on the variable-length ballast bracing. These two states are usually dependent on the load moment to be absorbed.

The horizontal distance between the axis of rotation of the superstructure or the axis of rotation of the superstructure and the center of gravity of the derrick ballast is referred to as the ballast radius. The ballast radius of the suspended ballast can be adjusted either via the inclination of the derrick boom or via a guide between the rear of the superstructure and the suspended ballast. A disadvantage of this type of suspended ballast is that the crane as a complete system can only be moved or rotated when the suspended ballast is raised from the ground. It should also be noted that the entire mass of the suspended ballast is not “active” as long as it is on the ground. The pull cylinders of the ballast tensioning system “take” the required part of the total mass of the suspended ballast and feed it into the boom system. The mass that is not required remains on the ground and is not involved in the crane lift.

If the derrick ballast is configured in the form of a ballast wagon with ballast elements stacked on it, the derrick ballast rests on a ballast wagon, which in turn becomes part of the overall derrick ballast. The additional advantage over the suspended ballast is that the entire crane and derrick ballast system can then be moved. The crane remains rotatable and can also be moved. The task of the ballast wagon is, on the one hand, to ensure that the crane can be moved and, on the other hand, to transfer the unneeded mass of the derrick ballast to the ground.

The previously known solutions for ballast wagons were usually expensive in-house designs by the crane manufacturers. These were integrated into the crane control system and were therefore relatively easy to handle. Crane operators often also have a relatively large number of standard heavy-load transport devices. These are mobile transport systems with their own drive and drive control that are capable of carrying and moving very large loads. For some time now, there have been efforts to use such heavy-load transport devices as ballast wagons for cranes.

One problem here is the independent control of the heavy-load transport devices, as their drive controls are not configured for the highly safety-relevant area of crane operation. The main problem is the need for a strong structural connection between the crane and the heavy-load transport device. This must be capable of transmitting even very large forces between the crane and the heavy-load transport device. If the crane and the ballast wagon do not move synchronously, such large forces can pose a risk during crane operation or even damage components. For this reason, the operation of heavy-load transport devices as ballast wagons is currently not permitted and their use is therefore at the risk of the crane operator.

The present invention is therefore based on the object of enabling the use of heavy-load transport devices for ballast wagons of cranes of the same type, in which the high safety requirements of crane operation are met and the risk of damage to the crane system is minimized.

According to the invention, this object is achieved by means of a crane having the features of the present disclosure.

Accordingly, a crane is proposed which comprises a movable undercarriage, a superstructure mounted rotatably on the undercarriage, a boom connected to the superstructure in a luffable manner, a derrick boom connected to the superstructure in an articulated manner, a crane control system, a guide connected to the superstructure and a derrick ballast. The undercarriage may comprise a crawler chassis. The boom is braced via the derrick boom, preferably via a length-adjustable cable bracing system as described above. The derrick boom is preferably connected to the superstructure via a derrick bracing, which is in particular adjustable in length, as described above.

The derrick ballast comprises a ballast plate on which several ballast elements can be stacked. The ballast plate, which can also be referred to as a ballast pallet, is connected to the derrick boom via ballast bracing on the one hand and to the superstructure, in particular the rear of the superstructure, via the aforementioned guide on the other. The ballast bracing is configured to be variable in length and may comprise two bracing strands, each with a pull cylinder. The guide is preferably configured as an at least partially rigid structure, for example as a lattice structure.

The derrick ballast also comprises a ballast wagon, which includes at least one standard heavy-load transport device with its own drive and drive control. Due to its own drive, the heavy-load transport device can also be referred to as a heavy load transport vehicle. The heavy-load transport device is in particular a mobile platform with several wheel axles or an SPMT (“Self-Propelled Modular Transporter”). Many crane operators are already using large numbers of such heavy-load transport devices to move heavy loads such as bridge elements or parts of drilling rigs.

In particular, the ballast plate is placed or fastened on a transport platform of the heavy-load transport device. The heavy-load transport device can have a load capacity of over 1000 tons, although smaller heavy-load transport devices with lower maximum loads can of course also be used.

The ballast wagon can comprise several coupled heavy-load transport devices. Therefore, when the ballast wagon or “the” heavy-load transport device is referred to in the following, the possibility of several coupled heavy-load transport devices, or a heavy-load transport device combination, is also to be included.

The guide may be connected to the ballast plate or the ballast wagon via a connection device. This refers to a mechanical connection. The connection device comprises a measuring device that is configured to detect a force that counteracts a relative movement between the ballast wagon and the guide. This force is referred to below as the control force.

The control force results from a non-uniform or non-synchronous movement of the crane or guide and ballast wagon. For example, if the superstructure rotates around the axis of rotation of the superstructure, the guide connected to the superstructure swivels. The ballast wagon must follow the movement of the guide, which is connected to the derrick ballast via the connection device, with a corresponding movement so that no excessive lateral forces are introduced into the guide or derrick boom. If, for example, the ballast wagon moves too quickly (i.e. the ballast wagon rushes ahead of the guide) or too slowly (i.e. the guide rushes ahead of the ballast wagon) or if the ballast wagon encounters an obstacle, a relative movement would occur without a fixed connection between the guide and the ballast wagon.

Due to the connection between the guide and the ballast wagon or ballast plate, which is provided by the connection device, a force occurs due to this uneven or non-synchronous movement, which is detected by the measuring device and used to control the movement of the ballast wagon. The crane control is connected to the drive control of the heavy-load transport device via a control connection (which in particular refers to a data connection here) and is configured to control and/or regulate the heavy-load transport device depending on the control force detected by the measuring device. If, in the following, reference is made to merely a “control” of the heavy-load transport device, this is intended to refer to a control and/or regulation or closed-loop control, respectively.

Therefore, no change in position of the ballast wagon relative to the crane or guide or a relative movement between the ballast wagon and crane is detected and used to control the heavy-load transport device, but rather a force resulting from a non-synchronous movement of the crane and ballast wagon. This may provide a stable or even a rigid connection between the guide and derrick ballast. An actual relative movement between the guide and ballast wagon is no longer required to control the ballast wagon. Steering errors and terrain influences can thus be corrected and the ballast wagon or the heavy-load transport device can be “forced” into track.

Furthermore, in the solution according to the disclosure, the control systems of the crane and the heavy-load transport device are connected to each other, i.e. communication takes place between the crane control system and the drive control system of the heavy-load transport device. This means that the heavy-load transport device can be controlled solely via the crane control system, while the drive control system of the heavy-load transport device is integrated into the crane control system. This simplifies the control of the overall crane and derrick ballast system and ensures that it is possible to react directly and optimally to movement sequences that result in a corresponding detectable control force. This makes it possible to avoid situations in which excessive lateral forces are introduced into the guide or the derrick boom by the powerful drive of the heavy-load transport device.

The connection device preferably provides a mechanical connection between guide and ballast plate, or guide and ballast wagon, which has at least one degree of freedom of movement, for example a relative translational movement parallel to the longitudinal axis of the guide and/or a relative rotation about a vertical axis (in the case of horizontal orientation of the guide and the ballast plate, this is preferably a vertical axis). This relative movement(s) can be locked by means of one or more actuators in order to provide a fixed connection in a defined force range and instead detect the forces occurring and use them to control the heavy-load transport device by the crane control system. As an alternative, the connection device may provide a rigid connection between the guide and the ballast plate, or between the guide and the ballast wagon. In this case, preferably only the forces occurring are measured and used to control the heavy-load transport device.

In a possible embodiment, the guide is configured in such a way that the force generated by the derrick ballast is divided into a first force introduced into the guide or transmitted through the guide and a second force introduced into the ballast bracing or transmitted through the ballast bracing. Together with the derrick boom, to the free end of which the ballast bracing is preferably connected, this results in a triangle of forces within which the very high forces resulting from the mass of the derrick ballast are transmitted. These forces resulting from the derrick mass, i.e. also their force components introduced into the crane via the guide and the ballast bracing, are in particular considerably greater than the control force, which is detected by the measuring device and on which the control of the heavy-load transport device by the crane control system is based.

In order that these high forces do not interfere with the detection of the control force by the measuring device, the measuring device is arranged outside the structures of the guide and the ballast bracing that transmit the first and second forces, i.e. outside the aforementioned triangle of forces. This not only enables effective detection of the control force on which the control of the heavy-load transport device by the crane control system is based, but also the use of a simpler sensor system that does not have to be configured for such high forces. Furthermore, such an arrangement increases the sensitivity of the measuring device (measuring systems configured for larger forces are less accurate when detecting smaller forces).

Preferably, the measuring device is located below the structures of the guide and the ballast bracing which transmit the first and second forces, preferably below the connecting means which connect the ballast bracing to the derrick ballast (i.e. in particular to the guide, the ballast plate or the connection device). It should be noted that the indications “below”, “above”, “bottom”, “top” etc. refer to the case where the crane and the derrick ballast stand on a flat horizontal surface. Furthermore, the indication “below” is not to be understood as meaning that the components concerned must overlap in plan view, but merely that the “lower” component is at a smaller distance from the ground than the “upper” component.

The measurement outside, in particular below the aforementioned triangle of forces, also enables high ballast radii, i.e. situations in which the ballast bracing does not extend vertically, but at an angle, as the connecting means of the ballast bracing on the derrick ballast are at a greater distance from the superstructure's axis of rotation than the free end of the derrick boom when viewed from above. This means that higher moments and therefore a higher maximum load capacity of the crane can be achieved with the same mass of derrick ballast.

In a further possible embodiment, it is provided that the measuring device comprises at least one first actuator, by means of which a control force acting in the longitudinal direction of the guide (also referred to herein as longitudinal force) can be detected. The at least one first actuator is preferably configured as a hydraulic cylinder, although other types of actuators, e.g. a hydraulic motor, are also possible in principle. In particular, the force is detected via a corresponding sensor integrated into the actuator (e.g. a pressure sensor).

Preferably, the first actuator is configured to provide a rigid connection between the guide and the ballast wagon in the longitudinal direction in a first force range in which the longitudinal force is less than a defined limit force. In the first force range, in which the longitudinal force is not too high, the first actuator therefore keeps the ballast wagon “on track” and blocks a relative movement resulting from a non-synchronous movement. The resistance that the first actuator offers to this relative movement results in a corresponding increase in force in the first actuator (e.g. an increase in pressure in one of the cylinder chambers of the hydraulic cylinder), which is detected by the measuring device and made available to the crane control system as a control force.

The defined limit force can be provided, for example, via a correspondingly configured or set pressure relief valve. If a pressure corresponding to the control force rises above the limit pressure set on the pressure relief valve, the valve opens and a further increase in pressure or force in the first actuator is prevented. The actuator then “slips through”.

Preferably, the crane control system is configured to control and/or regulate the heavy-load transport device depending on the detected longitudinal force in such a way that the longitudinal force is minimized. In the first force range, in which the longitudinal force is still relatively small, it is therefore used as a control variable for controlling the heavy-load transport device. The crane control system records the longitudinal force and determines which movement of the heavy-load transport device it must initiate so that the longitudinal force decreases again. Due to this control range, it is generally not necessary to stop the movement of the crane or of the ballast wagon. The compensating control of the heavy-load transport device is preferably automatic, i.e. without the intervention of the crane driver. Compared to existing systems, it is therefore much less necessary to intervene manually or after stopping the crane movement. In many cases, shutdowns can therefore be avoided.

In a further possible embodiment, the first actuator is configured to yield to a relative movement between the guide and the ballast wagon in a second force range in which the longitudinal force exceeds the defined limit force. If the longitudinal force thus becomes too high, the first actuator releases the movement of the ballast wagon relative to the crane or guide resulting from the non-synchronous movement, so that a further increase in force and thus damage to the crane components is prevented. The relative movement can be released, for example, via an appropriately set pressure relief valve, as described above.

The now released relative movement is recognized by the crane control and appropriate measures are initiated. For this purpose, the measuring device preferably comprises a first position sensor, by means of which a change in position of the ballast wagon relative to the guide can be detected. Preferably, a change in length or angle of the first actuator (e.g. an extension or retraction movement of a hydraulic cylinder) is detected directly. Alternatively, the change in the relative positions of the ballast wagon and guide could also be detected at any other point. Any sensors can be used for this purpose, for example optical distance sensors, magnetic proximity sensors, etc.

The crane control system is configured to stop or limit a movement of the crane and/or the ballast wagon in response to a change in position detected by the first position sensor. A compensating movement of the heavy-load transport device can then be carried out manually or automatically via the crane control system so that the first actuator can be blocked again and the movement of the crane-derrick-ballast combination can be continued.

For the control described above, it is preferable to consider not only the longitudinal forces, but also the forces or moments acting transversely to the longitudinal direction of the guide, which arise, for example, when the superstructure rotates if the ballast wagon does not move synchronously (e.g. because it encounters an obstacle or extends ahead due to a drop in terrain).

In a further possible embodiment, it is therefore provided that the measuring device comprises at least one second actuator, by means of which a torque counteracting a rotary movement between the ballast wagon and the guide can be detected. This torque is also referred to below as the control torque and is accompanied by a control force that does not act parallel to the longitudinal axis of the guide and is also referred to below as a transverse force. Such torques around the z-axis can occur, for example, during a rotation of the superstructure and corresponding circular movement of the ballast wagon, if the center of rotation of the crane and the center of rotation of the heavy-load transport device diverge (for example due to a steering error of the heavy-load transport device) or when the crane or the heavy-load transport device hits an eccentrically acting obstacle during a towing or parallel movement.

The at least one second actuator is preferably configured as a hydraulic cylinder, although other types of actuators, e.g. a hydraulic motor, are also possible in principle. Detection takes place in particular via a corresponding sensor integrated in the actuator (e.g. a pressure sensor). Preferably, the second actuator is configured to provide a rotationally rigid connection between the guide and the ballast wagon in a first torque range in which the control torque is less than a defined limit torque. Since the control torque can be easily converted into a corresponding control force and the defined limit torque into a corresponding limit force, the terms control torque and control force, limit torque and limit force as well as torque range and force range are used interchangeably in the following. In particular, it does not matter whether moments or forces are used in the control system, as the conversion can be carried out using a simple conversion factor.

In the first moment range, in which the control torque or the lateral force is not too high, the second actuator therefore keeps the ballast wagon “on track” and blocks a relative movement resulting from a non-synchronous movement. The resistance that the second actuator provides to this relative movement results in a corresponding increase in force in the second actuator (e.g. an increase in pressure in a cylinder chamber of the hydraulic cylinder), which is detected by the measuring device and provided to the crane control system as a control force or control torque.

The defined limit torque can be provided, for example, via a correspondingly configured or set pressure relief valve. If a pressure corresponding to the control torque rises above the limit pressure set on the pressure limiting valve, the valve opens and a further increase in pressure or force in the second actuator is prevented.

Preferably, the crane control system is configured to control and/or regulate the heavy-load transport device depending on the detected control torque in such a way that the torque resulting from the non-synchronous movement is minimized. The explanations on control/regulation based on the detected longitudinal force apply similarly for this, so that repetitions are not necessary.

In principle, it is conceivable that only the longitudinal forces are detected and balanced via at least one first actuator, or only the transverse forces or transverse moments are detected via at least one second actuator. Preferably, however, both first and second actuators are present (or one actuator acts as both a first and a second actuator) and both the longitudinal forces and the transverse forces or moments are detected and balanced.

In a further possible embodiment, it is provided that the second actuator is configured to yield to a relative rotation between the guide and the ballast wagon in a second moment range in which the detected control torque exceeds the defined limit torque. If the control torque or the corresponding lateral force becomes too high, the second actuator releases the movement of the ballast wagon resulting from the non-synchronous movement relative to the crane or the guide, so that a further increase in force and thus damage to the crane components is prevented. The relative movement can be released, for example, via an appropriately set pressure relief valve, as described above.

The now released relative movement is recognized by the crane control and appropriate measures are initiated. For this purpose, the measuring device preferably comprises a second position sensor, by means of which a change in position of the ballast wagon relative to the guide in the second force range can be detected. Preferably, a change in length or angle of the second actuator (e.g. an extension or retraction movement of a hydraulic cylinder) is detected directly. Alternatively, the change in the relative positions of the ballast wagon and the guide could be detected at any other point. Any sensors can be used for this purpose, for example optical distance sensors, magnetic proximity sensors or induction sensors, etc.

The crane control system is configured to stop or limit a movement of the crane and/or the ballast wagon in response to a change in position detected by the second position sensor. A compensating movement of the heavy-load transport device can then be carried out manually or automatically via the crane control system so that the second actuator can be blocked again and the movement of the crane-derrick-ballast combination can be continued.

In a further possible embodiment, it is provided that the connection device is arranged between the guide and the ballast plate and comprises a coupling part that is rigidly connected (for example bolted) to the guide. The connection device is preferably part of the guide, but in certain embodiments could also be considered part of the ballast plate.

In a further possible embodiment, it is provided that the coupling device comprises a movable element which is connected to the ballast plate. The movable element is movably mounted relative to the coupling part in the longitudinal direction of the guide and thus enables a certain movement of the ballast wagon relative to the crane or guide (when movement is enabled). If the ballast wagon or the heavy-load transport device moves relative to the crane parallel to the longitudinal direction of the guide, this would result in a corresponding movement of the movable element relative to the coupling part when the movable element is released (i.e. if it is not blocked by an actuator, for example). The movable element can, for example, be displaceably mounted on or in the coupling part of the connection device via a roller bearing or a plain bearing. The coupling part may comprise corresponding guide elements or rails for guiding the movable element.

Preferably, the movable element is arranged below the connecting means via which the ballast bracing is connected to the guide. The connecting means can be arranged on the guide itself or on the coupling part. This results in the previously described effect that the measuring device, which detects a control force opposing the movement of the movable element, is arranged below the aforementioned triangle of forces. The movable element can be plate-shaped.

In a further possible embodiment, it is provided that at least one first actuator is coupled on the one hand to the movable element and on the other hand to the guide. In particular, the first actuator is connected to the coupling part. The first actuator is preferably configured as a hydraulic cylinder and is configured to block a relative movement between the movable element and the coupling part up to the defined limit force. In contrast, the first actuator releases a relative movement if the longitudinal force exceeds the defined limit force. In particular, the hydraulic cylinder is oriented parallel to the longitudinal axis of the guide.

In a further possible embodiment, it is provided that the connection device comprises a rotation device via which the ballast plate is connected to the guide so that it can rotate about a vertical axis. The term “vertical” refers to the case where the crane is standing on a flat, horizontal surface and the guide is also oriented horizontally in particular. The rotation device comprises a pivot bearing, which is preferably arranged on the movable element, in particular on an underside of the movable element facing the ballast wagon. As a result, the combination of movable element and pivot bearing enables both a relative movement between the ballast wagon and crane in the longitudinal direction of the guide (i.e. towards or away from the crane) and a rotation of the ballast wagon relative to the crane.

In a further possible embodiment, it is provided that the pivot bearing comprises a first bearing part connected to the connection device and a second bearing part connected to the ballast plate. The aforementioned connections can each be direct or indirect. For example, the second bearing part can be connected directly to the ballast plate or, for example, to an intermediate piece, which in turn is connected to the ballast plate. In particular, the first bearing part is connected to the movable element.

At least one second actuator is coupled on the one hand to the movable element and on the other hand to the ballast plate. The second actuator can be coupled to the first bearing part and/or to the second bearing part, wherein it preferably couples both bearing parts together and thus directly monitors or detects the rotation between the two bearing parts and blocks it, if necessary. The second actuator is preferably configured as a hydraulic cylinder, but can alternatively be configured as a rotary actuator (e.g. as a hydraulic motor). The second actuator is configured to block relative rotation between the bearing parts up to the defined limit torque and to release rotation at a higher control torque.

In an alternative possible embodiment, instead of the movable element described, the connection device comprises at least two pivotably mounted rocker arms, via which the connection device is movably connected to the ballast plate (directly or indirectly). The rocker arms are preferably mounted directly on the coupling part. In the simplest case, the rocker arms can each be pivotably mounted on the coupling part and/or on the ballast wagon (or an intermediate piece connected to the ballast plate) about horizontal pivot axes.

Instead of a displaceable movable element, in this embodiment the rocker arms allow the ballast plate to move relative to the coupling part in the longitudinal direction of the guide. The rocker arms can be connected directly to the ballast plate or to an intermediate piece connected to the ballast plate, for example via bolt connections. The rocker arms are preferably arranged underneath connecting means, via which the ballast bracing is connected to the guide. The connecting means can be arranged on the guide itself or on the coupling part. This results in the previously described effect that the measuring device is arranged below the aforementioned triangle of forces.

The rocker arms can have an elongated shape and be of identical design. Several independently movable individual rocker arms can be provided. Alternatively, some of the rocker arms can be connected to each other (e.g. via coupling elements articulated to the rocker arms) and perform a joint movement.

In a further possible embodiment, it is provided that at least one first actuator is coupled on the one hand to a rocker or an intermediate piece that can be moved by means of the rocker and on the other hand to the guide, in particular to the coupling part. The first actuator is preferably in the form of a hydraulic cylinder and is configured to block a pivoting movement of the rocker arm up to the defined limit force. The at least one first actuator thus holds the rocker arms in a fixed position up to the defined limit force and only releases an oscillation or relative movement when the longitudinal force exceeds the defined limit force.

In principle, a first actuator can be assigned to each rocker arm. Alternatively, one or more rocker arms themselves may not be coupled to a first actuator. Because the first actuator blocks a rocker arm in the first force range, the other rocker arms cannot move and the longitudinal position of the ballast wagon relative to the crane is thus fixed.

Even in the embodiment with mobility in the longitudinal direction of the guide made possible by swinging, there is preferably a further degree of freedom of movement in the form of a rotation of the ballast wagon relative to the crane or to the guide about a particularly vertical axis of rotation in order to detect moments about the z-axis and to be able to block a relative rotary movement in the first moment range.

In a further possible embodiment, it is therefore provided that the connection device comprises a rotation device via which the ballast plate is connected to the guide so as to be rotatable about a vertical axis, wherein the rotation device is arranged on the coupling part or on an intermediate piece connecting the rocker arms to the ballast plate and comprising a pivot bearing with two bearing parts rotatable relative to one another. As already explained in relation to the embodiment with the movable element, the bearing parts can be connected directly (i.e. the actuator is connected directly to the bearing parts) or indirectly (i.e. the actuator is not connected directly to the respective bearing part at one end or at both ends, but to an element connected to the bearing part, such as the coupling part or an intermediate piece connected to the ballast plate), wherein the second actuator is configured to block relative rotation between the bearing parts up to the defined limit torque. The rotation device is preferably located between the rocker arms and the ballast plate, for example on an intermediate piece connected to the coupling part of the connection device via the rocker arms.

In a further possible embodiment, it is provided that the rotation is not made possible via a rotation device, but via the rocker arms themselves. At least four rocker arms are provided for this purpose, which are configured in particular as individual rocker arms. The rocker arms are configured in such a way that they allow the ballast plate to rotate relative to the coupling part. This can be made possible, for example, by the fact that the rocker arms are not attached to the coupling part and/or the ballast plate via a linear joint (mobility about one axis), but via a ball joint, a universal joint or any other joint device that allows pivoting movement about more than one axis. Alternatively, the rocker arms may comprise an additional joint between their attachment points that enables this mobility. At least one second actuator is coupled directly to at least one rocker arm or to an intermediate piece connecting the rocker arms to the ballast plate.

In a further possible embodiment, at least two second actuators are provided, each of which is coupled on the one hand to the coupling part and on the other hand to one of the rocker arms or to an intermediate piece connecting the rocker arms to the ballast plate and simultaneously act as first actuators. The fact that some rocker arms deflect in different directions relative to the guide during a rotary movement of the ballast wagon is utilized here. If the differently deflecting rocker arms are each coupled to a first actuator, these actuators are loaded differently (e.g. pressure increase for an actuator configured as a hydraulic cylinder in a first pressure chamber and for another actuator in the other pressure chamber).

Consequently, the second actuators are arranged in particular in such a way that they are loaded differently when the ballast plate is rotated relative to the coupling part, the crane control system being configured to receive the different loads (i.e. control torques or forces) from the measuring device and to control and/or regulate the heavy-load transport device depending on the load difference detected thereby.

In an alternative possible embodiment, it is provided that the connection device is not arranged between the guide and the ballast plate, but between the ballast plate and the heavy-load transport device. In this case, a relative movement between the heavy-load transport device and the ballast plate is monitored and, in particular, blocked or, if necessary, released via first and/or second actuators. The ballast bracing can be connected directly to the ballast plate.

The connection device comprises at least one adapter element, which comprises a first adapter part connected to the ballast plate and a second adapter part which can be moved relative to the first adapter part in the longitudinal direction of the guide and which is connected to the heavy-load transport device. The monitored and possibly blocked/released relative movement therefore takes place between the two adapter parts of the at least one adapter element.

At least one first actuator, which is preferably configured as a hydraulic cylinder, is coupled to the first and second adapter parts and is configured to block a relative movement between the adapter parts up to the defined limit force. The adapter element and the first actuator are oriented with their longitudinal axes parallel to the longitudinal axis of the guide in particular. One of the adapter parts can be an outer adapter part in which the other, inner adapter part is slidably mounted. Corresponding bearings, for example plain or roller bearings, are fitted between the adapter parts. The outer adapter part can, for example, be connected to the heavy-load transport device, while the inner adapter part is connected to the ballast plate. The reverse arrangement is also conceivable.

Even in the embodiment with a mobility in the longitudinal direction of the guide, which is made possible by intermediate adapters or adapter elements installed between the ballast plate and the heavy-load transport device, there is preferably a further degree of freedom of movement in the form of a rotation of the heavy-load transport device relative to the ballast plate and thus to the crane about a particularly vertical axis of rotation in order to be able to detect moments about the z-axis and block a relative rotational movement in the first moment range.

In a further possible embodiment, at least two adapter elements are therefore provided, which are spaced apart from one another transversely to the longitudinal axis of the guide and each comprise at least one first actuator. The adapter elements are configured such that the second adapter parts are not only displaceable parallel to the longitudinal axis of the guide relative to the first adapter parts, but that they are also pivotable laterally thereto, in particular in a plane which contains the longitudinal axes of the adapter elements (in particular, this is a plane parallel to the ballast plate or to a transport platform of the heavy-load transport device). For this purpose, appropriately configured bearings can be installed between the first and second adapter parts, which enable such a lateral relative movement of the adapter parts. Furthermore, the adapter parts or the bearings must have an appropriate amount of play so that the second adapter parts can move laterally. The bearings can be spherical for this purpose, for example. Eight or more bearing points can be provided per adapter element, for example four bearing points in each end area of the adapter elements, two at the bottom and two at the top.

Preferably, the first actuators also function as second actuators and are arranged in such a way that they are loaded differently when the heavy-load transport device or the ballast wagon is rotated relative to the ballast plate. The crane control system is configured to control and/or regulate the heavy-load transport device depending on the detected load difference. The principle of the differently acting loads can correspond to that previously explained in relation to the embodiment with the rocker arms.

In another possible embodiment, the guide comprises a head piece with a coupling portion rigidly connected to the rest of the structure of the guide and a pivot part connected to the ballast plate. The head piece can be connected directly to the superstructure. Alternatively, the head piece can be connected to a linkage piece of the guide, which in turn is connected to the superstructure, in particular pivotably connected to the superstructure. Alternatively, one or more intermediate pieces of the guide can be installed between the head piece and the linkage piece.

The pivot part comprises a first pivot element connected to the ballast plate and a second pivot element connected to the coupling portion. The coupling portion can be formed directly on the second pivot element or be a component connected to it. The two pivot elements are mounted so that they can swivel relative to each other about a swivel axis extending parallel to the longitudinal axis of the guide. The pivot elements allow the ballast plate to rotate about the aforementioned swivel axis. For example, the first pivot element can be rotatably mounted in the second pivot element, with corresponding bearings (e.g. plain or roller bearings) preferably being arranged between the pivot elements. The pivot elements can be tubular. The ballast bracing is preferably connected directly to the ballast plate via appropriate connecting means.

In an alternative possible embodiment, it is provided that the connection device is arranged between the guide and the ballast plate. Instead of a coupling of the ballast wagon and guide that is movable in the longitudinal direction of the guide and a corresponding detection and possibly blocking of relative movements by first and/or second actuators, a rigid connection between the guide and ballast wagon is provided in the longitudinal direction of the guide. For this purpose, the connection device comprises a coupling part which is rigidly connected to the guide. The connection between the coupling part and the guide or ballast plate can in turn be direct or indirect (for example via one or more rigidly connected intermediate pieces). The measuring device comprises at least one force measuring bolt, by means of which a longitudinal force counteracting a relative movement between the ballast wagon and the guide in the longitudinal direction of the guide can be detected, wherein the crane control is preferably configured to control and/or regulate the heavy-load transport device depending on the detected longitudinal force in such a way that the longitudinal force is minimized. The longitudinal axis of the force measuring bolt is preferably oriented perpendicular to the longitudinal axis of the guide.

In this embodiment, it is therefore not intended that a relative movement in the longitudinal direction of the guide is released when a defined limit force is exceeded. Instead, the longitudinal force is detected directly as a control force for controlling compensating movements of the heavy-load transport device via one or more force measuring bolts, which is/are part of a rigid bolt connection of the connection device. Preferably, the at least one force measuring bolt is arranged below the connecting means via which the ballast bracing is connected to the guide.

Preferably, the connection device comprises an intermediate piece connected to the coupling part via the at least one force measuring bolt, which in turn is connected to the ballast plate. The intermediate piece can have a box-shaped structure.

In a further possible embodiment, it is provided that the connection device comprises a rotation device with two bearing parts that can rotate against each other, via which the ballast plate is connected to the coupling part so that it can rotate about a vertical axis, wherein the bearing parts are preferably coupled to each other directly or indirectly via at least one second actuator, which is configured to block rotation between the bearing parts up to the defined limit torque. The coupling part is therefore not completely rigidly connected to the ballast plate, but there is a degree of freedom of movement in the form of rotation of the ballast wagon relative to the coupling part. The rotary connection, the detection of the control torque and the corresponding control of the heavy-load transport device can be configured as in the embodiments described above.

In a further possible embodiment, it is provided that the coupling part is not only rigidly connected to the guide, but also rigidly connected to the ballast plate (directly or indirectly), i.e. no degrees of freedom of movement are provided between the guide and the ballast wagon via the connection device. In order to nevertheless detect a control torque resulting from a non-synchronous movement of the ballast wagon and to be able to control the heavy-load transport device accordingly, at least two, but preferably at least four force measuring bolts are provided, which are arranged in such a way that they are loaded differently when the ballast plate is rotated relative to the guide. The crane control system is configured to control and/or regulate the heavy-load transport device depending on the detected load difference.

Preferably, the crane control and/or the force measuring bolts are configured to determine a position or direction of a force vector acting on the connection device, wherein the crane control can determine whether it is a pure longitudinal force or a torque or a superposition of a longitudinal force and a torque.

In a further possible embodiment, it is provided that the coupling part comprises connecting means via which the ballast bracing is connected to the connection device or the guide, wherein the at least one force measuring bolt is part of a bolt connection located below the said connecting means, preferably a bolt connection of the coupling part to the ballast plate or to an intermediate piece connected to the ballast plate. As a result, the force measuring bolts are located outside the force triangle described above and can be configured to be correspondingly smaller or to detect smaller forces and torques.

In a further possible embodiment, it is provided that the crane comprises at least one rigging block, wherein the rigging block comprises first connecting means for connecting to the ballast bracing and second connecting means for connecting to the ballast plate. The bracing block can thus be mounted on the ballast plate if required and the ballast bracing can be connected to the at least one bracing block. The connection between the bracing block and the ballast bracing can be articulated and allow pivoting movement about a horizontal axis. The ballast plate can also be removed from the ballast wagon, wherein the bracing blocks and the ballast plate are configured in such a way that the derrick ballast can be used as a suspended ballast when the bracing block is mounted and after separation from the ballast wagon. Preferably, two bracing blocks are provided to keep the suspended ballast stable.

This allows the derrick ballast to be converted into a suspended ballast. To do this, the bracing blocks are mounted on the ballast plate, the ballast bracing is connected to the connecting means of the bracing blocks and the ballast plate is separated from the ballast wagon or the heavy-load transport device so that the ballast plate with the ballast elements stacked on it can be lifted off. The bracing blocks can be installed with the ballast plate placed on the floor.

The suspended ballast can be used with or without a guide. When used with the guide attached (i.e. it is still connected to the ballast plate, for example by one of the connection devices described above), the connection between the bracing blocks and the ballast bracing and/or the connection between the bracing blocks and the guide can be articulated. Alternatively, the suspended ballast could be used without a guide, wherein the suspended ballast is then located below the free end of the derrick boom and the ballast bracing extends essentially vertically.

In a further possible embodiment, the guide is configured to be adjustable in length. For this purpose, the guide can, for example, comprise a linkage piece connected to the superstructure and at least one intermediate piece that can be detachably installed between the linkage piece and the connection device. The length of the guide can then be adjusted by installing or removing a corresponding number of intermediate pieces.

Alternatively or additionally, the guide may comprise a telescopic piece with at least two sections mounted so that they can be moved into and out of one another, in particular by means of an actuator (e.g. a telescopic cylinder), which changes the length of the guide. The telescopic piece can replace a linkage piece of the guide and be mounted directly on the superstructure, in particular pivotably articulated. It is also conceivable that the telescopic piece represents an intermediate piece and is installed between a linkage piece and a head piece or a connection device, wherein the head piece or the connection device is connected to the ballast plate. It is also conceivable that the telescopic piece is a head piece or a connection device and is connected to the ballast plate. The said head piece or the said connection device can be arranged on one of the displaceable sections. It is also conceivable that one of the sections forms a linkage piece, while a section slidably relative thereto forms a head piece or a connection device, i.e. that the telescopic section itself forms the entire guide. In the aforementioned examples, the connection device can be configured in accordance with one of the previously described embodiments.

In a further possible embodiment, it is provided that the ballast plate is placed on the ballast wagon, in particular directly on the at least one heavy-load transport device, and is detachably connected to it via connecting elements. The ballast plate can thus be mounted on various heavy-load transport devices and can even be used as a suspended ballast without a ballast wagon.

In another possible embodiment, it is provided that the guide is mounted on the superstructure so that it can pivot about a horizontal axis, in particular via a linkage piece. This allows the height of the derrick ballast to be changed. Alternatively or additionally, the bracing of the crane can be configured in such a way that the horizontal distance between the center of gravity of the derrick ballast and the axis of rotation of the superstructure (i.e. the ballast radius) is greater than the horizontal distance between the tip of the derrick boom and the axis of rotation of the superstructure. This results in a higher maximum load capacity of the crane with the same mass of derrick ballast, but also a greater load on the guide, as the force exerted by the derrick ballast is divided into a force component transmitted via the ballast bracing and a force component transmitted via the guide. The measuring device is therefore preferably arranged outside the force triangle formed by these force components and the force transmitted via the derrick boom, in particular below this force triangle.

In a further possible embodiment, it is envisaged that the control connection comprises two separate and, in particular, diverse data connections between the crane control unit and the drive control unit of the heavy-load transport device. Here, a first data connection can preferably comprise a data bus, for example a CAN bus, and/or a second data connection can comprise at least one safety switching device with a safety relay contact. At least one safety switching device can be provided on the heavy-load transport device and at least one safety switching device on the crane. The second data connection can itself comprise two separate data connections, each of which is assigned a safety switching device on the crane side or a safety switching device on the heavy-load transport device side.

The safety switching device can be configured to transmit a signal to the respective receiver so that a signal transmitted via the first data connection (e.g. a command) can be accepted or verified. The receiver can be the drive control unit or the crane control unit. A command sent via the first data connection is therefore only executed if a corresponding data communication takes place via the second data connection. This results in increased safety for the crane control system.

In a further possible embodiment, it is provided that the control connection comprises two emergency stop signal chains with a first emergency stop switch arranged on the crane and a second emergency stop switch arranged on the heavy-load transport device. The crane control is preferably configured to stop all movements of the crane and the heavy-load transport device when one of the two emergency stop switches is actuated. Preferably, the heavy-load transport device has its own, self-sufficient emergency stop signal chain, which is electronically coupled to the emergency stop signal chain of the crane via the at least one safety switching device.

In a further possible embodiment, it is provided that the crane comprises an inclination detection device with at least one sensor for detecting an inclination of the derrick ballast, in particular an inclination of the ballast plate. The crane control system is preferably configured to control and/or regulate the heavy-load transport device on the basis of the data provided by the inclination detection device in such a way that a current inclination of the terrain is compensated. This can, for example, prevent the heavy-load transport device from moving ahead of the crane on a negative inclination (i.e. downhill travel) or slowing down the heavy-load transport device relative to the crane on a positive inclination (i.e. uphill travel). In particular, the crane control is configured to increase a drive pressure of the drive of the heavy-load transport device when a positive terrain gradient is detected and to reduce it when a negative terrain gradient is detected. The drive can be a hydraulic drive.

In a further possible embodiment, it is provided that the crane comprises at least one actuator arranged on the ballast wagon and/or on the ballast plate, by means of which the ballast plate and/or the ballast wagon can be raised or pivoted relative to the ground. For example, an area of the ballast plate can be raised relative to the ballast wagon in order to change the inclination of the ballast plate. Alternatively or additionally, it may be possible to change the inclination of the ballast plate by changing the axles of the ballast wagon. This can be used, for example, to compensate for an inclination of the ballast plate that deviates from the horizontal orientation. For this purpose, the crane control system is configured to control and/or regulate the at least one actuator on the basis of the data provided by the inclination detection device in such a way that the ballast plate is held in a horizontal orientation. Alternatively, the heavy-load transport device can have an actuator on at least one wheel axle for lifting a transport platform relative to the wheel axle. This can also be used to level the ballast plate mounted on the heavy-load transport device.

### BRIEF DESCRIPTION OF THE FIGURES

Further features, details and advantages of the disclosure result from the exemplary embodiments explained below with reference to the figures. The figures show in:

FIG. 1: a perspective view of the crane according to a first exemplary embodiment;

FIG. 2: a side view of the derrick ballast of the crane;

FIG. 3: a schematic representation of the occurring and transmitted forces;

FIGS. 4a-c: possible travel modes of the crane-derrick ballast combination, each in a top view;

FIG. 5: a perspective view of the guide with connection device and ballast plate of the crane according to the first exemplary embodiment;

FIGS. 6-7: the connection device of the first embodiment in different views;

FIG. 8: a perspective view of the movable element of the connection device of the first embodiment;

FIGS. 9-10: sections along and transverse to the longitudinal axis of the guide through the connection device of the first embodiment;

FIG. 11: an enlarged view of the ballast plate and its connection to the heavy-load transport device in a perspective view;

FIG. 12: a perspective view of the guide with connection device, ballast plate and ballast wagon according to a second exemplary embodiment;

FIG. 13: a perspective view of the connection device of the second embodiment;

FIG. 14: a perspective view of the guide with connection device, ballast plate and ballast wagon according to a third exemplary embodiment;

FIGS. 15-16: a perspective view and a sectional view along the longitudinal axis of an adapter element of the third embodiment;

FIG. 17: a perspective overall view of the crane according to the third exemplary embodiment;

FIG. 18: a perspective view of the guide with connection device, ballast plate and ballast wagon according to a fourth exemplary embodiment;

FIG. 19: a perspective overall view of the crane according to the fourth exemplary embodiment;

FIG. 20: a side view of the guide including the connection device, ballast plate and ballast wagon according to a fifth exemplary embodiment;

FIG. 21: a side view of the guide including the connection device, ballast plate and ballast wagon according to a sixth embodiment, with the derrick ballast being used as a suspended ballast; and

FIGS. 22-23: schematic representations of the control systems and data connections of the crane and the heavy-load transport device.

### DETAILED DESCRIPTION

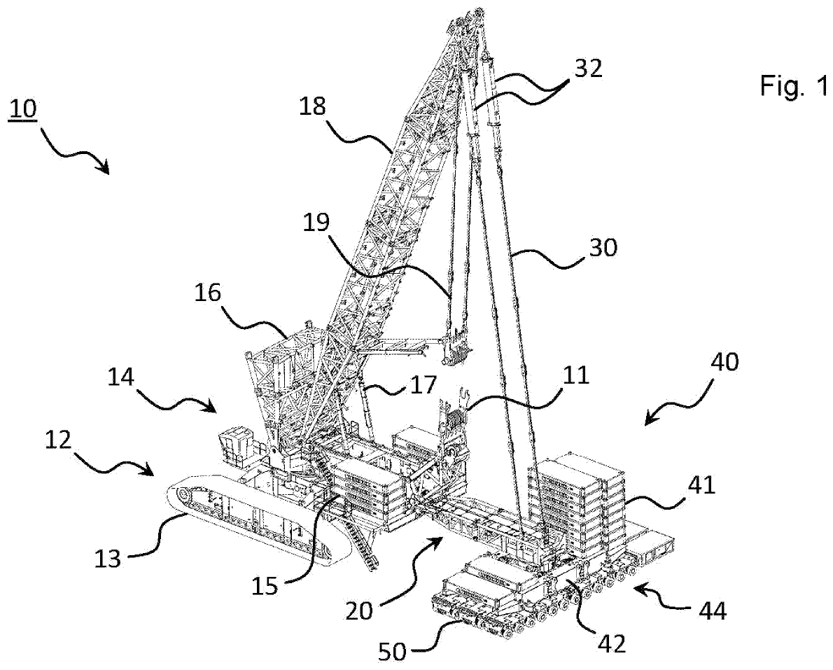

FIG. 1 shows a first exemplary embodiment of the crane 10 in a perspective overall view. The crane 10 is a crawler crane with a lattice boom as the main boom 16 (hereinafter referred to only as the “jib”), wherein only the linkage piece of the boom 16 is shown in FIG. 1, which is articulated to the superstructure 14 about a horizontal luffing axis. The crane 10 comprises an undercarriage 12 with crawler tracks. The undercarriage 12 is supported on the ground by the two lateral crawler carriers 13 of the crawler undercarriage. The crane 10 can be moved via the two crawler carriers 13. This movement is possible in straight-ahead travel, which can take place forwards and backwards. The crawler carriers 13 can also move their crawler tracks at different speeds so that the crane 10 can travel around bends.

On the undercarriage 12, a superstructure 14 is mounted on the undercarriage 12 via a slewing gear to rotate about a vertical axis of rotation (also referred to herein as the superstructure axis of rotation). In addition to the boom 16, the crane 10 comprises a derrick boom 18, which is also hinged to the superstructure 14 so that it can pivot about a horizontal pivot axis. A superstructure ballast 15 with several stacked ballast elements (divided into two lateral ballast stacks in the exemplary embodiment shown here) is located at the rear of the superstructure. The derrick boom 18 is connected to the boom 16 via a variable-length cable bracing system not shown. The derrick boom 18 is in turn connected to the rear of the superstructure via a variable-length derrick bracing 19. The connection to the superstructure 14 can be made via an additional, swivel-mounted bracing block 11 (also known as an A-block or SA-block) (the cable reeving between A-block 11 and derrick bracing 19 is not shown in FIG. 1). An operator's cab can be located at the front of the superstructure 14.

In addition to the superstructure ballast 15, the crane 10 comprises a derrick ballast 40 with a ballast wagon 44 that can be moved on the ground, to which a ballast plate 42 is attached, on which in turn several ballast elements 41 are stacked. The derrick ballast 40 is connected to the rear of the superstructure via a guide 20 and to the tip or free end of the derrick boom 18 via a variable-length ballast bracing 30. In the exemplary embodiment shown here, the ballast bracing 30 comprises two parallel bracing strands, each with a hydraulic pull cylinder 32, by extending and retracting which the length of the bracing strands of the ballast bracing 30 can be changed and thus the weight acting through the derrick ballast 40 can be adjusted.

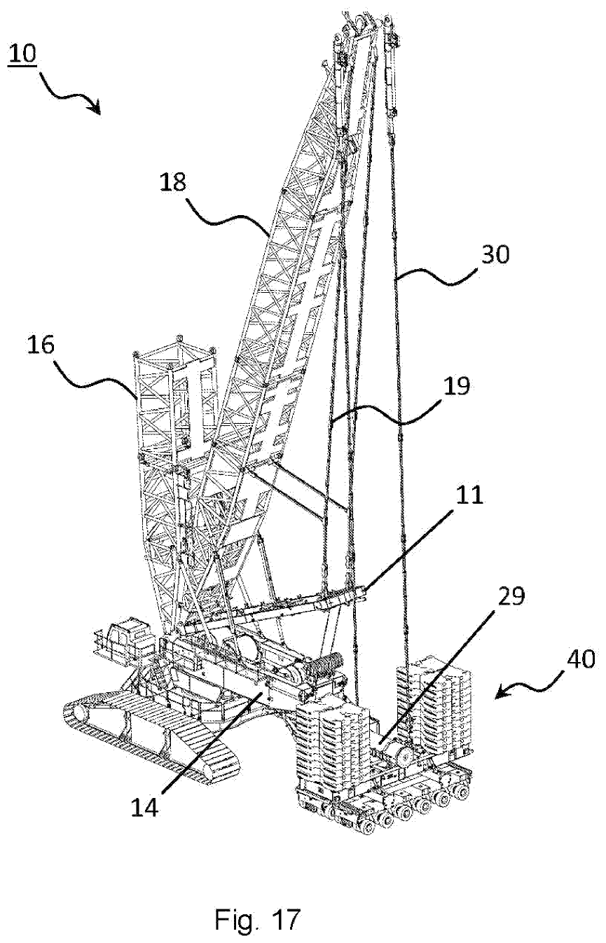

With regard to the functions of the cable bracing system, derrick bracing 19 and ballast bracing 30 as well as the derrick ballast 40, reference is made to the introductory remarks, which also apply to the crane 10 according to the exemplary embodiment shown here. A repetitive explanation is therefore largely dispensed with. In addition, in the exemplary embodiment shown here, the derrick boom 18 is held in position against the force of the derrick bracing 30 via a fallback safety device, which can comprise two hydraulic fallback supports 17, which follow the movement of the derrick boom 18 and exert a corresponding supporting force on the derrick boom 18. The boom 16 can also have a corresponding fallback safety device (see FIG. 17).

The ballast wagon 44 of the derrick ballast 40 comprises a standard heavy-load transport device 50 (hereinafter referred to as SPMT) known from the prior art, which is already available to many crane operators and users for various purposes and has its own drive with its own drive control. The ballast wagon 44 may comprise a single SPMT 50 or several SPMT 50 coupled together (or connected via the ballast plate 42)-the number is not important in the present case. In particular, the ballast plate 42 is placed on a transport surface or platform of the SPMT 50.

Since the drive control of the SPMT 50 is not configured for safety-relevant crane operation and there is also a risk that the very powerful drive of the SPMT 50 will exert excessive forces, in particular lateral forces, on the guide 20 and the derrick boom 18, the solution according to the present disclosure provides for the control systems of crane 10 and SPMT 50 to be connected to one another so that the SPMT 50 can be controlled via the crane control 90. In addition, the crane 10 comprises a connection device 60, which is either part of the guide 20 or an independent device and comprises a measuring device by means of which forces resulting from a non-synchronous movement of the crane 10 and ballast wagon 44 can be detected. These detected control forces Fs are transmitted to the crane control 90 and used by it to control the SPMT 50, so that non-synchronous or divergent movements are compensated and the most synchronous travel operation possible is ensured.

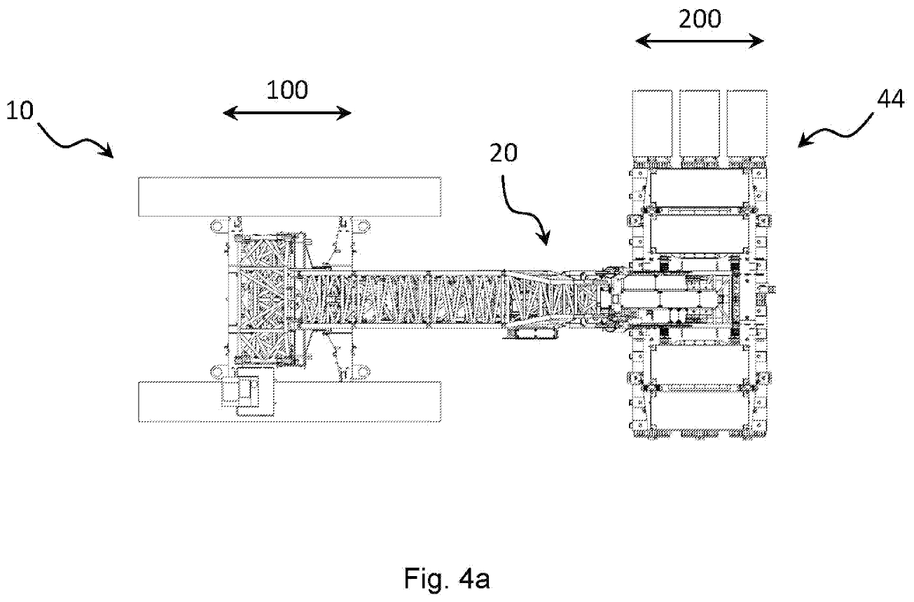

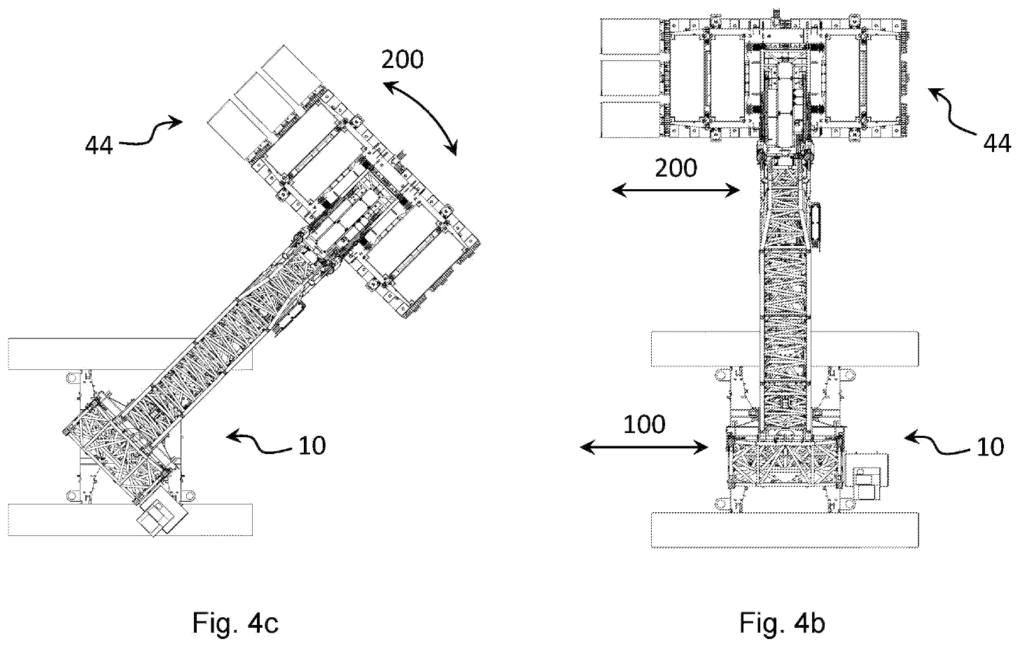

A non-synchronous movement of ballast wagon 44 and crane 10 can occur for various reasons or in different situations. FIGS. 4a-4c show three possible movement modes of the crane 10 in a plan view, with the arrow 100 indicating the direction of travel of the crane 10 and the arrow 200 indicating the direction of travel of the ballast wagon 44 or the SPMT 50.

FIG. 4a shows a towing movement of the crane system, in which crane 10 (or undercarriage 12) and ballast wagon 44 move one behind the other in the same direction (i.e. straight ahead or backwards) parallel to the longitudinal axis of guide 20. If, for example, the ballast wagon 44 now encounters an obstacle on one side, high forces or torques can be generated without authorization, which can lead to damage to the crane components, in particular the guide 20. This can lead to the generation of torques around the z-axis and/or the y-axis (see FIG. 3).

FIG. 4b shows a parallel movement of the crane system, in which the crane 10 (or undercarriage 12) and ballast wagon 44 move offset to each other in the same direction (i.e. straight ahead or backwards) transverse to the longitudinal axis of the guide 20. If the guide 20 is connected to the ballast wagon 44 via a rotation device, parallel travel can also take place at an angle of less than 90° to the longitudinal axis of the guide 20. If the ballast wagon 44 encounters an obstacle here, forces act transversely to the longitudinal axis of the guide 20, so that moments can arise around the z-axis and around the y-axis (see FIG. 3).

Finally, FIG. 4c shows a rotation of the superstructure 14 around its axis of rotation (also referred to as circular travel). In this case, the undercarriage 12 can remain stationary and the ballast wagon 44 moves around the superstructure rotation axis as a rotation or steering center at a speed that is adapted to the rotation speed of the superstructure 14. Apart from the possibility that the ballast wagon 44 encounters an obstacle, it is possible that the center of rotation of the ballast wagon 44 does not coincide with the axis of rotation of the superstructure or that the ballast wagon travels too fast or too slow. This can also result in moments around the z-axis and the y-axis (see FIG. 3).

High forces or moments can also occur during any movement if the ballast wagon 44 sinks into the ground due to the high mass of the derrick ballast 40 (e.g. normal forces of the guide 20 increase up to the maximum propulsive force of the crane 10) or if the ballast wagon 44 moves faster or slower than the crane 10 (straight travel: ballast wagon 44 travels faster/slower than the undercarriage 12; rotation/circular travel: the ballast wagon 44 travels faster/slower around the center of rotation of the SPMT 50 than the superstructure 14 rotates around the axis of rotation of the superstructure or the undercarriage 12 moves around its center of rotation when cornering). When towing, torques can arise around the y-axis in particular, while torques can also arise around the z-axis when turning/circling or traveling in parallel and generally when hitting eccentrically acting obstacles. Moments around the x-axis are added if the terrain inclination varies or the ballast wagon 44 sinks in. There will often be a combination of moments around all three axes, with certain moments dominating depending on the type of movement and the reason for the non-synchronous movement.

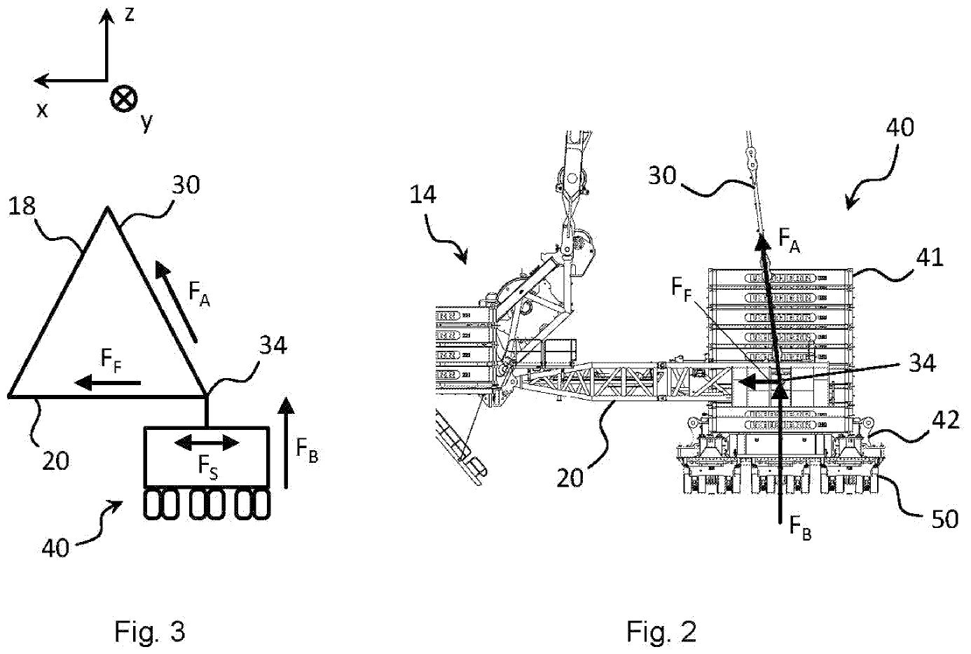

FIG. 2 shows a side view of the derrick ballast 40, with the forces that occur during operation and are introduced into the crane system shown as black arrows (the lengths and directions of the arrows are merely schematic and are for illustrative purposes only). The ballast wagon 44 and thus the SPMT 50 is connected to the crane system via the triangle formed by the legs guide 20, ballast bracing 30 and derrick boom 18. This triangle is shown schematically in FIG. 3, together with the respective forces.

A compressive force is generated in the guide 20 depending on the “activated” mass or weight force F_{B} from the derrick ballast 40. This “activation” takes place via the pull cylinders 32 and the ballast bracing 30. When the pull cylinders 32 are retracted, the leg with the ballast bracing 30 is shortened so that the mass of the derrick ballast 40 can be used as required or the force F_{B} introduced into the crane system can be adjusted. This “activation” creates a moment that prevents the crane 10 from tipping over and a force that keeps the boom system 14, 16 in balance. Consequently, these forces introduced into the crane system are generally very high, so that it is not readily possible to install a sensor system in this highly stressed area (i.e. in the guide 20 or in the ballast bracing 30) to detect forces resulting from non-synchronous movements and to control the SPMT 50 safely.

The guide 20 is pivotably mounted on the superstructure 14. The derrick boom 18 preferably remains motionless when the pull cylinders 32 are actuated. This results in minimal movement at the connection between the crane system and derrick ballast 40 in the vertical direction. As long as the mass of the derrick ballast 40 is large enough, this movement remains imperceptible and essentially only the force F_{B} resulting from the mass of the derrick ballast 40 and “activated” via the setting of the pull cylinders 32 increases. At the connecting means 34 of the ballast bracing 30, which connect the latter to the guide 20, this force F_{B} is divided into a force F_{A} introduced into the crane system via the ballast bracing 30 and a force F_{F} introduced into the crane system via the guide 20. These forces are very large and, together with the forces transmitted via the derrick boom 18, form a triangle of forces along the legs shown in FIG. 3.

A force F_{S} that is located outside this triangle should therefore be used as the control force for controlling the SPMT 50. The measuring device for detecting this force is therefore located outside this force triangle, in particular below the force triangle or below the connecting means 34. In this area, the control forces F_{S} are not superimposed by the other forces F_{A} and F_{F} so that the measuring device can be configured for smaller forces.

The purely vertical force FB is transmitted by the connection between the guide 20 and the SPMT 50, wherein a connection device 60 is part of this connection and comprises the aforementioned measuring device, which is connected to the crane control 90 and exchanges data with the latter. Depending on the embodiment, the connection device 60 can be installed between guide 20 and ballast plate 42 or between ballast plate 42 and ballast wagon 44 or SPMT 50. If there is unequal travel between the wheel sets of the SPMT 50 and the crawler carriers 13 of the crane 10, the force F_{B} remains vertical, but this results in a control force F_{S} transverse to or at a certain angle to the force F_{B}. The connection between the ballast wagon 44 and the guide 20 is flexurally rigid, particularly at an angle of 90°, wherein the control force F_{S} generates a moment around the flexurally rigid connection.

The crane system or the SPMT 50 is controlled in two different force ranges depending on the control force or forces F_{S} detected (in the following, the terms force or force range are also used to refer to the torques resulting from non-synchronous movement). In a first force range, in which the control force Fs is still relatively small, the control force F_{S} is used as a control and/or regulating variable for the movement of the SPMT 50. The crane control 90 receives the detected control force Fs from the measuring device and determines which movement it must initiate so that the control force Fs becomes smaller again. Due to the comparatively low control forces Fs in this first force range, it is generally not necessary to stop the crane movement; instead, the crane control system automatically performs a continuous movement as desired by the crane operator. The crane control system merely adjusts the movement of the SPMT 50 so that the control force F_{S} is minimized, in particular by accelerating or decelerating the SPMT 50 or adjusting the speed and/or steering angle.

In a second force range, the control force F_{S} that occurs is specifically limited in order to prevent damage. The second force range is above a defined limit force, wherein different limit forces or limit torques can be defined for the different forces and torques that occur, e.g. a defined limit force for a control force F_{S} in the longitudinal direction of the guide (longitudinal force) and another defined limit force or a defined limit torque for a control torque occurring around the z-axis (transverse force).

When the limit force is exceeded, i.e. in the second force range, the force F_{S} should be constant and a detectable movement should occur between the ballast wagon 44 and the guide 20, which can be detected by the measuring device. During the execution of this movement, the crane control 90 preferably intervenes and stops the movement of the crane system, i.e. the lower wagon 12, the superstructure 14 and the SPMT 50. This ensures that the crane system remains in a safe state. The ballast wagon 44 can then be moved back into a “safe area” and the crane movement can be continued. The correction or the movement of the SPMT 50 back into the safe area can be carried out by a crane operator, an instructor or fully automatically by the crane control 90.

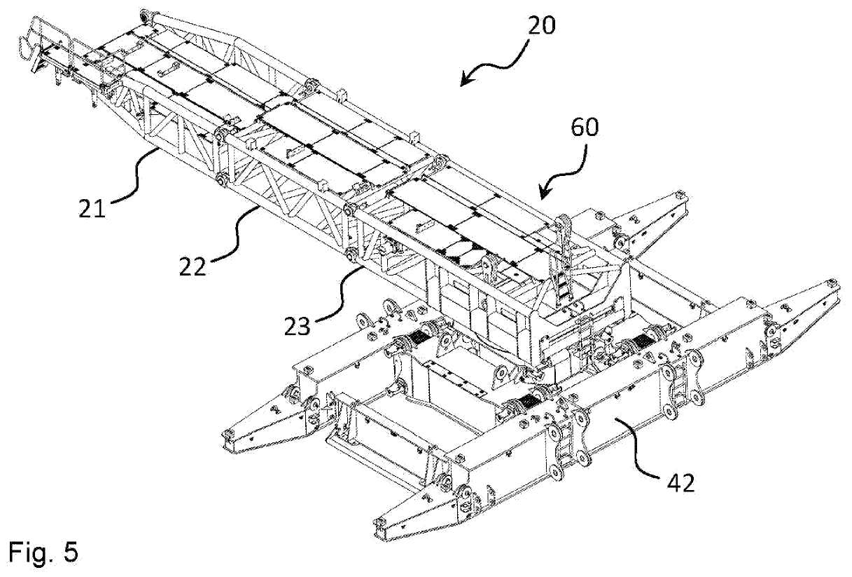

In the following, several embodiments of the crane 10 are discussed with reference to FIGS. 5-21, in particular with regard to the realization of the connection device 60 and the detection of the control forces F_{S}.

A first exemplary embodiment is shown in FIGS. 5-10. FIG. 5 shows a perspective view of the guide 20, the connection device 60 and the ballast plate 42, which are connected to each other. The ballast elements 41 and the ballast wagon 44 with the SPMT 50 are not shown.

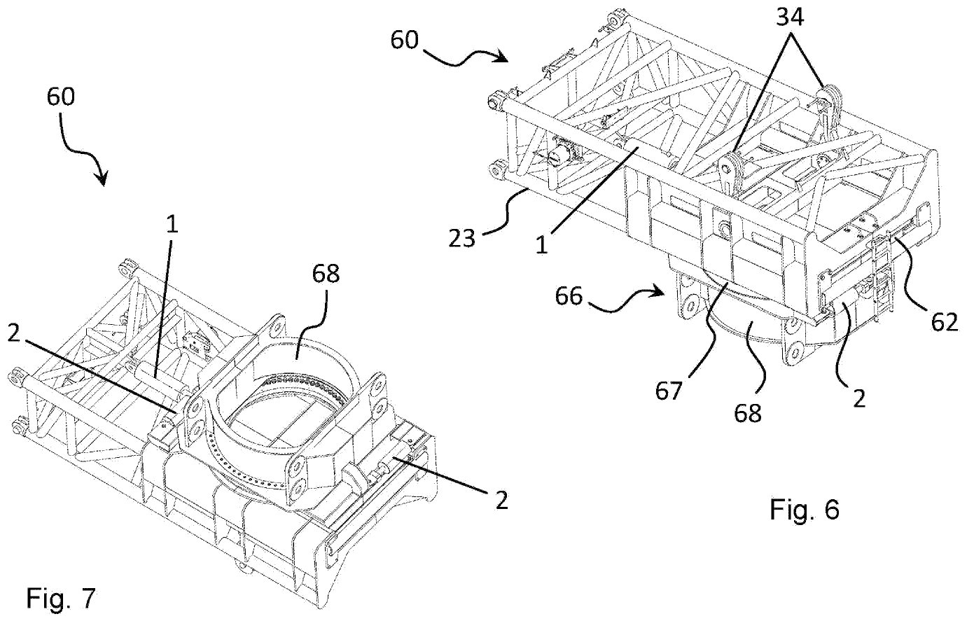

The guide comprises a linkage piece 21 connected to the rear of the superstructure pivotably about a horizontal pivot axis and an intermediate piece 22 connected to the linkage piece 21 via bolt connections (in particular fork-finger connections), which can comprise a lattice structure with several longitudinal, transverse and diagonal struts. The connection device 60 is bolted to the intermediate piece 22 and connected to the ballast plate 42 and forms part of the guide 20 in this exemplary embodiment. The connection device 60 comprises a coupling part 23 rigidly connected to the intermediate piece 22 and a movable element 62 displaceably mounted on or in the coupling part 23 in the longitudinal direction of the guide 20, which can be better recognized in FIGS. 6 and 7. FIG. 6 shows the connection device 60 with a view of the upper side 34, while FIG. 7 shows a view of the underside of the connection device 60.

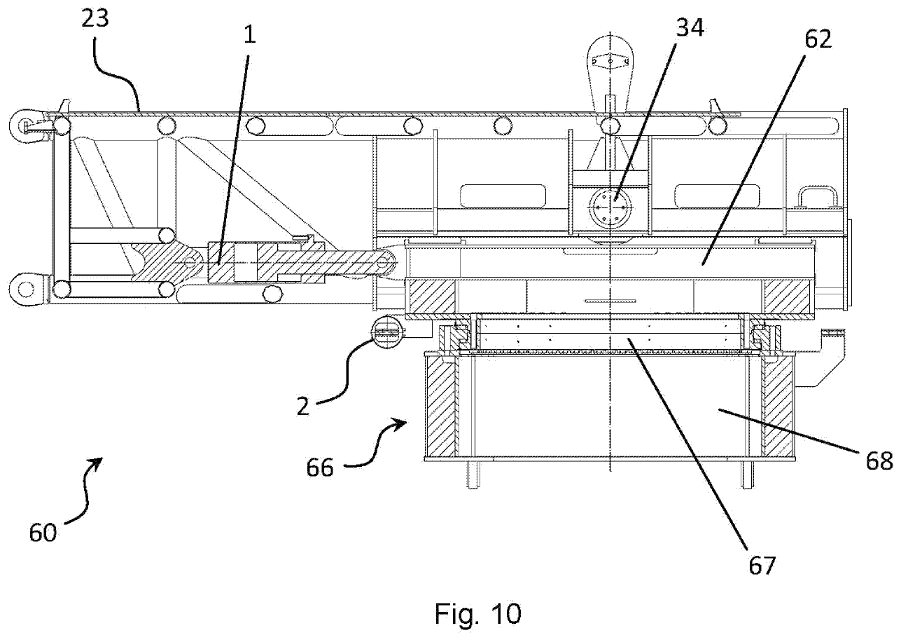

In this exemplary embodiment, the movable element 62 is configured as a plate-shaped element, which is displaceably mounted in guide rails that extend on the coupling part 23 in the longitudinal direction of the guide 20. The mobility of the movable element 62 is ensured by bearings 64, which may be plain or roller bearings, for example. FIG. 9 shows a cross-section through the connection device 60 transverse to the longitudinal axis of the guide 20, from which the position and shape of the guide rails, the bearings 64 and the movable element 62 can be seen. A section along the longitudinal axis of the guide 20 is shown in FIG. 10.

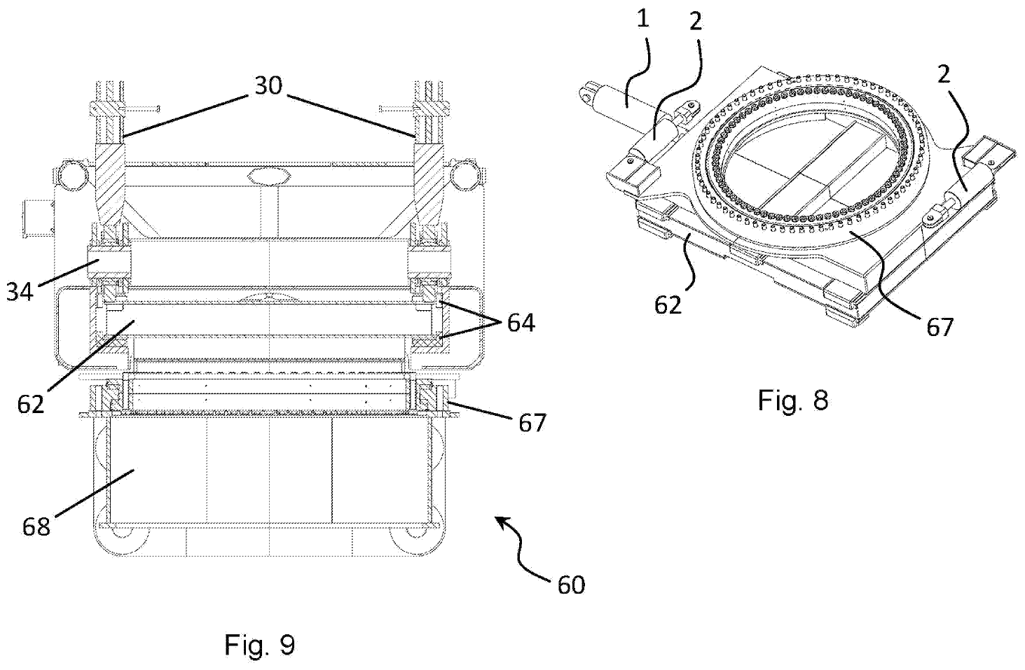

On the underside of the movable member 62 facing the ballast plate 42, there is a rotation device which allows rotation of the ballast plate 42 relative to the guide 20 about an axis perpendicular to the direction of expansion of the ballast plate 42 (i.e. about a vertical axis or about the z-axis in the case of a horizontally oriented guide 20). The rotation device comprises a pivot bearing 66 having a first bearing portion 67 connected to the movable member 62, and a second bearing portion 68 rotatably connected to the first bearing portion 67 and forming an intermediate piece bolted directly to the ballast plate 42. Alternatively, further intermediate pieces could be provided between the second bearing part 68 and the ballast plate 42. The movable element 62 with the first bearing part 67 is shown isolated in FIG. 8 with a view of its underside.

The connection device 60 thus has two degrees of freedom of movement and permits a relative translational movement of the ballast plate 42 or the ballast wagon 44 attached thereto parallel to the longitudinal axis of the guide 20 (i.e. towards or away from the superstructure 14) as well as a rotation of the ballast plate 42 or the ballast wagon 44 relative to the guide 20.

As can be seen in FIGS. 5 and 6, the connecting means 34 for the ballast bracing 30, which are configured as bolt-on points, are arranged on the coupling piece 23 and are located on its upper side. The movable element 62 and the pivot bearing 66 are therefore located below the connecting means 34 and, in particular, below the structures of the guide 20, which transmit the high forces F_{F} resulting from the derrick ballast 40. The resultant force from the rod force and the pulled ballast weight goes in particular directly from the connecting means 34 into the corner tubes of the guide 20.

If the crane 10 and the ballast wagon 44 do not move synchronously (e.g. for one of the reasons explained with reference to FIGS. 4a-4c), a relative movement between the ballast plate 42 and the guide 20 occurs. This can mean a displacement of the movable element 62 relative to the coupling part 23 and/or a rotation of the second bearing part 68 relative to the first bearing part 67. Such relative movements should be avoided in the first force range or minimized by appropriate counter-control of the SPMT 50.

For this purpose, the connection device 60 comprises a first actuator 1, which in the exemplary embodiment shown here is configured as a hydraulic cylinder 1, which is connected on the one hand to the coupling part 23 and on the other hand to the movable element 62 and extends parallel to the longitudinal direction of the guide 20 (i.e. the degree of freedom of movement of the movable element 62) (cf. FIGS. 6-7). As can be seen in FIG. 10, this can be a double-acting hydraulic cylinder. In the first force range, the first actuator 1 blocks a movement of the movable element 62 relative to the coupling part 23. This can be achieved, for example, by a pressure relief valve hydraulically connected to the first actuator 1 (not shown), which remains closed up to a defined limit pressure and blocks a displacement of the piston rod. As a result, the movable element 62 is held in a central position in the first force range (see FIG. 10).

A sensor of the measuring device, in particular a pressure sensor, is used to detect the control force Fs or longitudinal force acting in the longitudinal direction of the guide 20, which acts on the first actuator 1 due to a non-synchronous movement of the crane 10 and ballast wagon 44. If the longitudinal force is smaller than the defined limit force (which results, for example, from the set limit pressure of said pressure relief valve), the movement of the movable element 62 is blocked and the detected longitudinal force is used by the crane control 90 to control the SPMT 50 in such a way that the deviating movement is compensated and the longitudinal force is reduced. This prevents the crane 10 from being switched off.

A torque occurring around the z-axis that results from a non-synchronous movement (=control torque) is detected via second actuators 2. In the exemplary embodiment discussed here, two second actuators 2 are provided, which are also configured as hydraulic cylinders. Alternatively, the pressure and rotation monitoring could also be implemented with one or more rotary actuators. The second actuators 2 are articulated to both the first bearing part 67 and the second bearing part 68 (see FIGS. 7 and 8), i.e. they are coupled between the ballast plate 42 and the coupling part 23, so that the torques act on the second actuators 2 about the axis of rotation of the pivot bearing 66. As with the first actuator 1, the second actuators 2 block a rotary movement of the second bearing part 68 relative to the first bearing part 67 up to a defined limit force or a defined limit torque. Here too, the limit torque can be defined by at least one pressure relief valve. Corresponding sensors (in particular pressure sensors) detect the forces acting on the second actuators 2 due to the control torque, i.e. the corresponding transverse forces, and the crane control 90 controls the SPMT 50 on this basis in such a way that the control torque is minimized due to a corresponding compensating movement.

The blocked first and second actuators 1, 2 force the ballast wagon 44 “into the track” in the first force range. Because the first and second actuators 1, 2 are located below the force triangle shown in FIG. 3, they can be made significantly smaller and the measured control forces F_{S} are not superimposed by the high forces F_{A} and F_{F}.

To prevent damage, the first and second actuators 1, 2 open when the respective limit force or the respective limit torque is exceeded, so that a corresponding relative movement between the ballast wagon 44 and the guide 20 is released. The relevant actuators 1, 2 move a certain distance. If, for example, the longitudinal force exceeds the defined limit force of the first actuator 1, this releases a movement of the movable element 62 relative to the coupling part 23 and, during the subsequent movement, the piston rod moves relative to the cylinder housing of the first actuator 1. The same applies to the second actuators 2. These position changes of the actuators 1, 2 are detected by corresponding position or attitude sensors of the measuring device and passed on to the crane control unit 90. The crane control 90 then stops all movements of the crane 10 and the SPMT 50. As an alternative to detecting a movement of the actuators 1, 2, the relative movements in question could also be detected by other means, e.g. by position or proximity sensors arranged on the movable element 62, on the coupling part 23, on the first bearing part 67 and/or on the second bearing part 68.

In summary, the degrees of freedom of movement provided by the connection device 60 are therefore only released when the forces or moments in question become too great. The respective actuators 1, 2 then “slip” and the detected movement causes the crane control 90 to stop the movement of the crane-derrick ballast assembly so that a correction can be made.

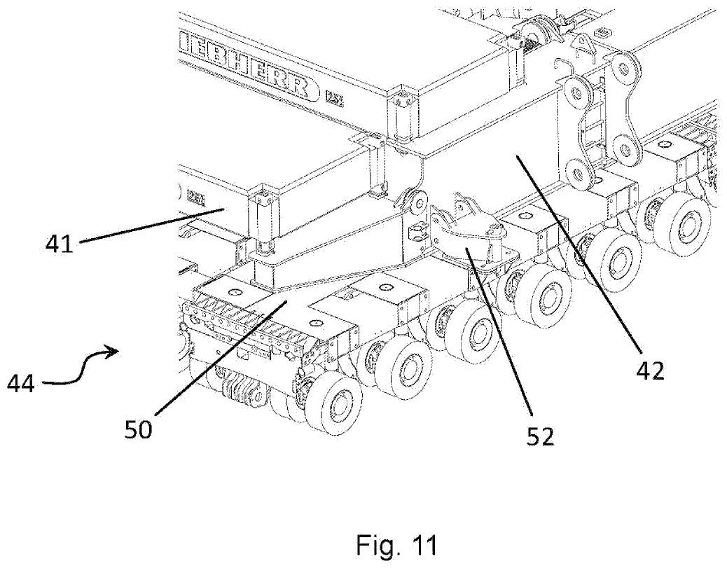

In particular, the ballast plate 42 is connected to the SPMT 50 via connecting elements 52. A possible example of such a detachable connection is shown in FIG. 11. In this case, the ballast plate 42 can be removed from the ballast wagon 44 or the SPMT 50 by releasing the connections provided by the connecting elements 52.

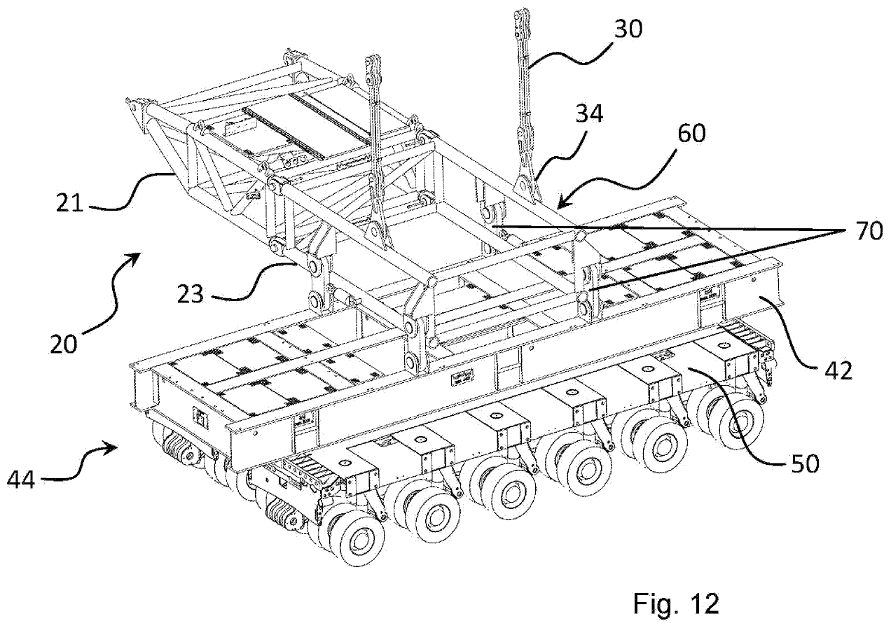

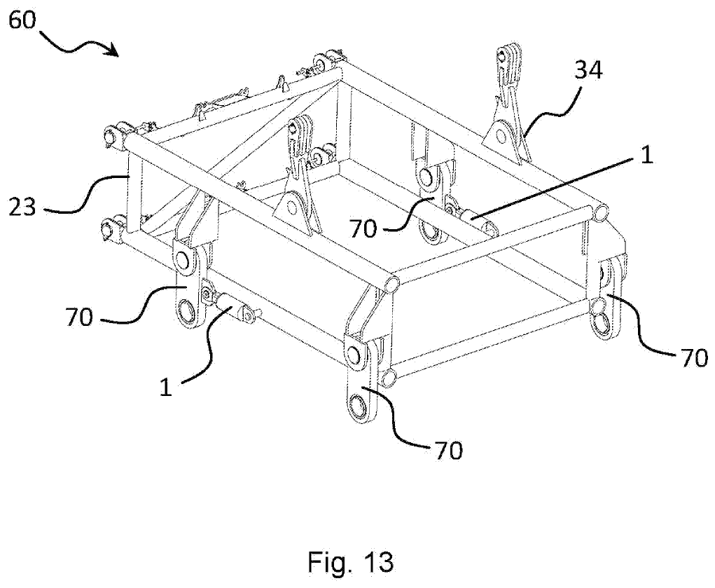

A second exemplary embodiment is shown in FIGS. 12 and 13. Here, the connection device 60 does not comprise a movably mounted element 62 and a pivot bearing 66, but a coupling piece 23 with four rocker arms 70, each of which is pivotably mounted on the coupling piece 23 about a pivot axis extending perpendicularly to the longitudinal axis of the guide 20 (and horizontally in the case of a flat base). The independently movable rocker arms 70 can, as shown in FIG. 12, be attached to the side of the coupling piece 23, although other arrangements are also possible, e.g. on the underside of the coupling piece 23.

In the exemplary embodiment shown here, the lower ends of the rocker arms 70 are hinged directly to the ballast plate 42. Alternatively, the rocker arms 70 could be hinged to an intermediate piece and the intermediate piece could in turn be connected to the ballast plate 42.

Due to the mobility of the rocker arms 70, the ballast plate 42 can move relative to the coupling part 23 in the longitudinal direction of the guide 20, similar to the movable element 62 of the first exemplary embodiment. In the embodiment variant shown here, two rocker arms 70 on opposite sides of the coupling part 23 are each coupled to the coupling part 23 via a hydraulic cylinder (see FIG. 13). On the one hand, these hydraulic cylinders act as first actuators 1, as they can detect the control force F_{S} or longitudinal force acting in the longitudinal direction of the guide 20 in the event of a non-synchronous movement. The principle of blocking the relative movement in a first force range and releasing the movement in a second force range functions similar to the first exemplary embodiment. In the first force range, the first actuators 1 hold the rocker arms 70 in a central position (see FIG. 13) and are again monitored for length and force or pressure by corresponding sensors of the measuring device.

The connecting means 34 for the ballast bracing 30 are again located above the first actuators 1 (in particular on the upper corner stems of the coupling part 23, as shown in FIG. 13), so that the latter are arranged below the triangle of forces.

In the embodiment shown here with four individual rocker arms 70, the hydraulic cylinders can function simultaneously as second actuators 2 if the rocker arms 70 have or are mounted on corresponding spherical bearings that allow the rocker arms 70 to be deflected in different directions or have degrees of freedom in 2 axes. In this case, when the ballast plate 42 rotates relative to the coupling part 23 about the z-axis, the rocker arms 70 on the different sides of the coupling part 23 are deflected in different directions (or in the first force range, the control forces F_{S} act in different directions). In this case, the crane control 90 is configured to recognize the different loads and to derive a control torque from this, on the basis of which a corresponding control of the SPMT 50 takes place, in a manner similar to the first exemplary embodiment. To enable this variant, at least four individual rocker arms 70 must be provided. These can, for example, be connected to the coupling part 23 and/or to the ballast plate 42 (or an intermediate piece) via spherical plain bearings and/or have an additional joint arranged between the pivot points of the rocker arms 70.

Alternatively, the control torque could also be detected via an additional rotation device with corresponding force and length monitoring via at least one second actuator 2, for example similar to the first exemplary embodiment. Such a rotation device could be arranged on an intermediate piece, which is connected to the coupling part 23 via the rocker arms 70.

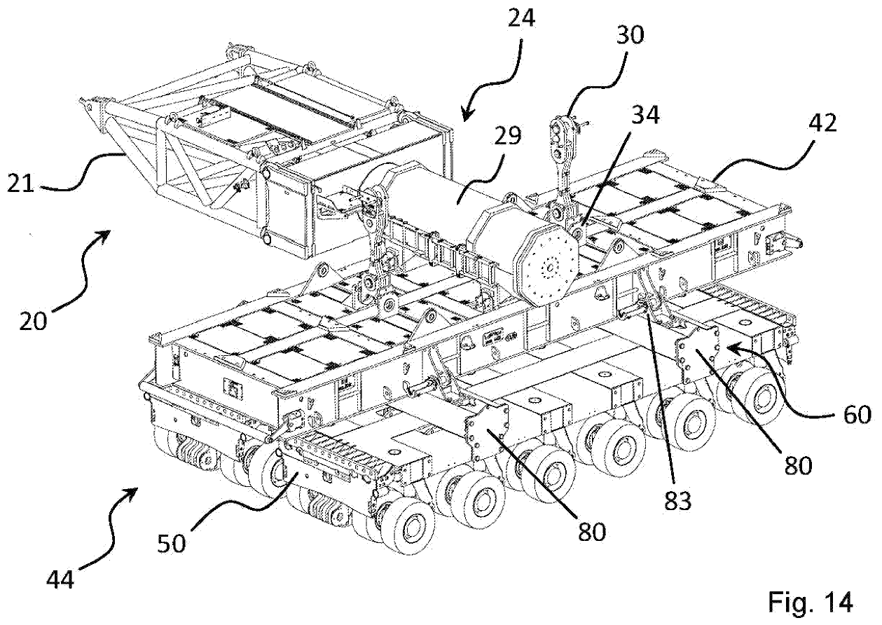

A third embodiment is shown in FIGS. 14-17. FIG. 14 shows the guide 20, the connection device 60, the ballast plate 42 and the SPMT 50 to which the ballast plate 42 is connected. Here, the guide 20 comprises only the linkage piece 21 and a head piece 24 connected thereto with a coupling portion rigidly connected to the linkage piece 21 and a pivot part 29 connected to the ballast plate 42. In this embodiment, the pivot part 29 comprises two tubular elements pivotably mounted relative to one another about the longitudinal axis of the guide 20, an inner tubular element (=first pivot element) being connected to the ballast plate 42 via corresponding connection points and an outer tubular element (=second pivot element) being connected to the coupling portion. Alternatively, the outer tubular element could be connected to the ballast plate 42 via corresponding connection points. The tubular elements allow the ballast plate 42 to rotate relative to the guide 20 about the longitudinal axis of the guide 20 (which corresponds to the x-axis when the guide 20 is oriented horizontally).

In this embodiment, the connection device 60 is not located between the guide 20 and the ballast plate 42, but between the ballast plate 42 and the ballast wagon 44 or SPMT 50. The connection device 60 comprises two adapter elements 80 (alternatively, only one adapter element 80 or more than two adapter elements 80 may be provided), which are spaced apart in the longitudinal direction of the SPMT 50 (i.e. transverse to the longitudinal axis of the guide 20) and provide the corresponding degrees of freedom of movement of the ballast wagon 44 relative to the guide 20.

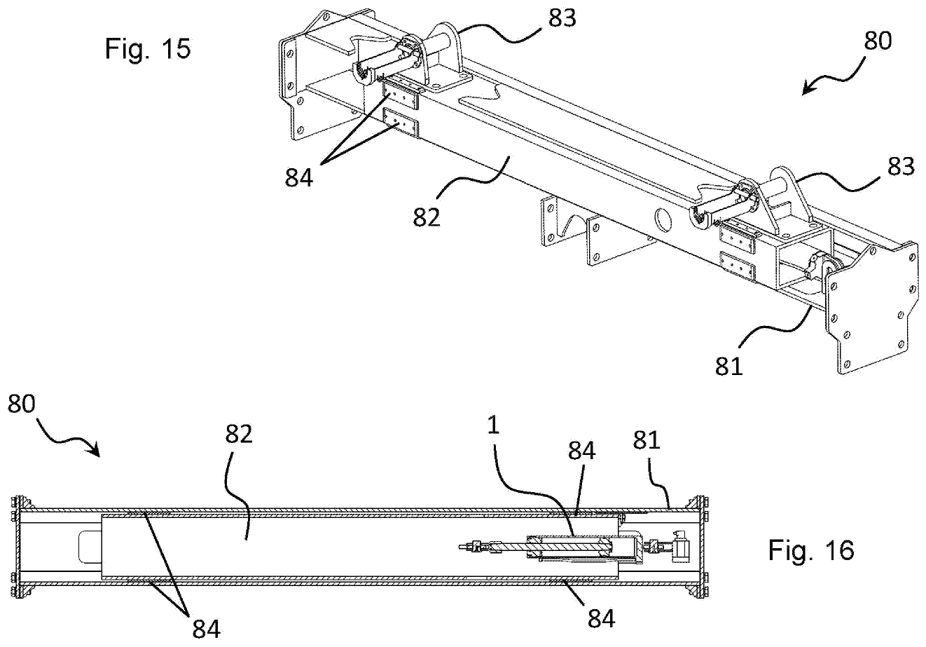

For this purpose, the adapter elements 80 each comprise an (outer) first adapter part 81, which is connected to the SPMT 50, and an (inner) second adapter part 82, which is displaceably mounted in the outer adapter part 81. FIGS. 15 and 16 each show a single adapter element 80 in a perspective view (FIG. 15) and in a lateral sectional view along the longitudinal axis of the adapter element 80 (FIG. 16). The second adapter parts 82 have corresponding connecting elements 83, which protrude through the casings of the first adapter parts 81 and can be connected or are connected to the underside of the ballast plate 42 (see FIG. 15). The first adapter parts 81 comprise corresponding connecting elements for connecting to the SPMT 50. Alternatively, the first (outer) adapter parts 81 could be connected to the ballast plate 42 and the second (inner) adapter parts 82 could be connected to the SPMT 50.

The adapter elements 80 comprise a bearing arrangement in order to ensure that the adapter parts 81, 82 can move relative to one another, wherein the bearing arrangement can comprise a plurality of bearings 84, which can, for example, be configured as plain bearings or roller bearings. FIGS. 15 and 16 show a possible arrangement of the bearings 84, wherein a lower and an upper bearing 84 are provided on each side and on each end portion of the second adapter part 82, thus a total of eight bearings 84 per adapter element 80. Of course, a different arrangement or a different number (e.g. less or more than eight) of bearings 84 could also be used.

The first and second adapter parts 81, 82 are connected to each other via a first actuator 1 in the form of a hydraulic cylinder (see FIG. 16), so that the longitudinal forces resulting from a non-synchronous movement can be detected. The principle of blocking the relative movement in a first force range and releasing the movement in a second force range functions similarly to the first and second exemplary embodiments. In the first force range, the first actuators 1 hold the adapter parts 81, 82 in a central position (see FIG. 16) and are in turn monitored for length and force or pressure by corresponding sensors of the measuring device.

In this exemplary embodiment, the connecting means 34 for connecting the ballast bracing 30 are arranged directly on the ballast plate 42. The flow of force therefore takes place on the one hand from the ballast plate 42 via the connecting means 34 into the ballast bracing 30 and on the other hand via the pivot part 29 into the guide 20. Since the adapter elements 80 of the connection device 60 are arranged below the ballast plate 42, the first actuators 1 are in turn located below the triangle of forces.

In order to enable the moments around the z-axis to be detected by means of the adapter elements 80, the latter can be configured in such a way that the second adapter parts 82 are not only mounted so as to be longitudinally displaceable relative to the first adapter parts 81, but can also be moved or swung out laterally relative to them. In this case, the first actuators 1 of the adapter elements 80 would be loaded differently, from which the crane control 90 can derive the control torque and control the SPMT 50 accordingly. In this case, the first actuators 1 would simultaneously act as second actuators 2. The principle functions in particular similarly to the corresponding variant of the second exemplary embodiment with the four rocker arms 70 and the first actuators 1 acting as second actuators 2. In order to enable this mobility, the bearings 84 can be configured accordingly and have a corresponding clearance. The bearings 84 can, for example, be spherical for this purpose. The ballast wagon 44 can then rotate about the z-axis with the second adapter parts 82 relative to the ballast plate 42 with the first adapter parts 81. However, this movement is only released in the second force range. In the first force range, the rotational movement is blocked and the SPMT 50 is controlled accordingly in order to compensate for the control torques and forces.

FIG. 17 shows a perspective overall view of the crane 10 according to the third exemplary embodiment, wherein it can be seen that the pivot part 29 is arranged between two ballast stacks stacked laterally on the ballast plate 42.

FIG. 17 also shows an example in which the superstructure 14 has an additional A-frame 11, which is pivotably mounted on the superstructure 14 and connected to the derrick boom 18 via the derrick bracing 19. The A-frame 11 is in turn connected to the superstructure 14 via a variable-length bracing cable. The crane 10 can have such a configuration irrespective of the specific configuration of the guide 20 or the derrick ballast 40.

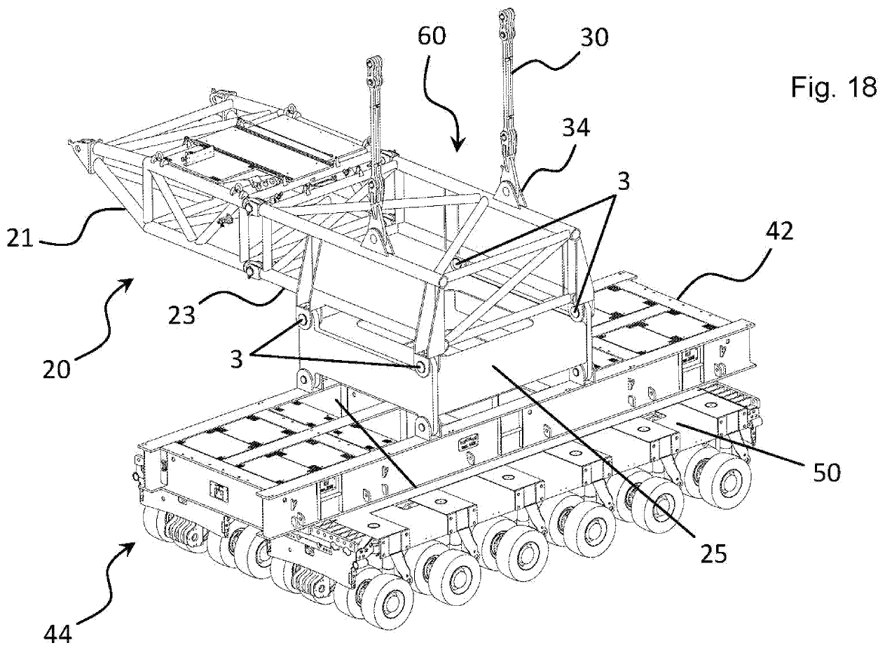

A fourth embodiment is shown in FIG. 18, wherein the guide 20, the connection device 60, the ballast plate 42 and the SPMT 50, to which the ballast plate 42 is connected, are shown. Here, the guide 20 comprises a linkage piece 21 and a connection device 60 connected to the linkage piece 21, which in turn is connected to the ballast plate 42. The connection device 60 comprises a coupling part 23 bolted to the linkage piece 21 and an intermediate piece 25 bolted to the ballast plate 42. In contrast to the previous embodiments, the connection device 60 in this embodiment does not provide a degree of freedom of movement, but is rigidly connected both to the linkage piece 21 and to the ballast plate 42. The intermediate piece 25 can be regarded as a component of the connection device 60 or the guide 20.

The intermediate piece 25 is bolted to the coupling part 23, wherein at least one of the bolts is configured as a force measuring bolt 3. In particular, the longitudinal axis of the force measuring bolt 3 is transverse to the longitudinal axis of the guide 20. In the embodiment variant shown here, four bolt connections are provided and all four bolts are configured as force measuring bolts 3, the longitudinal axes of which are oriented transversely to the longitudinal axis of the guide 20. The force measuring bolts 3 detect the longitudinal forces acting in the longitudinal direction of the guide 20, which are provided as a control force F_{S} of the crane control 90. A defined limit force can be provided up to which the SPMT 50 is controlled to compensate for the control force F_{S} in the same way as in the previous embodiments, i.e. without the current crane movement having to be stopped. If the defined limit force is exceeded, the crane control 90 can stop the movement.

In this exemplary embodiment, the connecting means 34 for connecting the ballast bracing 30 are arranged on the coupling part 23 so that the measuring device with the force measuring bolts 3 is located below the force triangle. This allows the force measuring bolts 3 to be smaller.

The torques around the z-axis can be detected by evaluating the forces detected by the various force measuring bolts 3. For this purpose, force measuring bolts 3 can be used, which are configured to detect the direction of the applied force, i.e. the position of the force vector. When a torque is applied around the z-axis, the force measuring bolts 3 are loaded differently, from which the control torque can be deduced. The crane control 90 can then initiate a corresponding compensating movement of the SPMT 50.

Alternatively, the connection device 60 could comprise a rotation device, for example similar to the first exemplary embodiment. This could be provided on the intermediate piece 25 or on a further component of the connection device 60 and be monitored for length and force via at least a second actuator 2. The functional principle for detecting the control torque would then be particularly similar to the first exemplary embodiment.

Alternatively, the force measuring bolts 3 could be provided in the connection between the intermediate piece 25 and the ballast plate 42. It would also be conceivable to dispense with the intermediate piece 25 and bolt the coupling part 23 directly to the ballast plate 42 via the force measuring bolts 3.

In all the embodiments shown above, any number of additional intermediate pieces 22 can be fitted in the guide 20 in order to be able to adapt the overall length of the guide 20 to a required ballast radius or a specific level of ballast torque, for example.

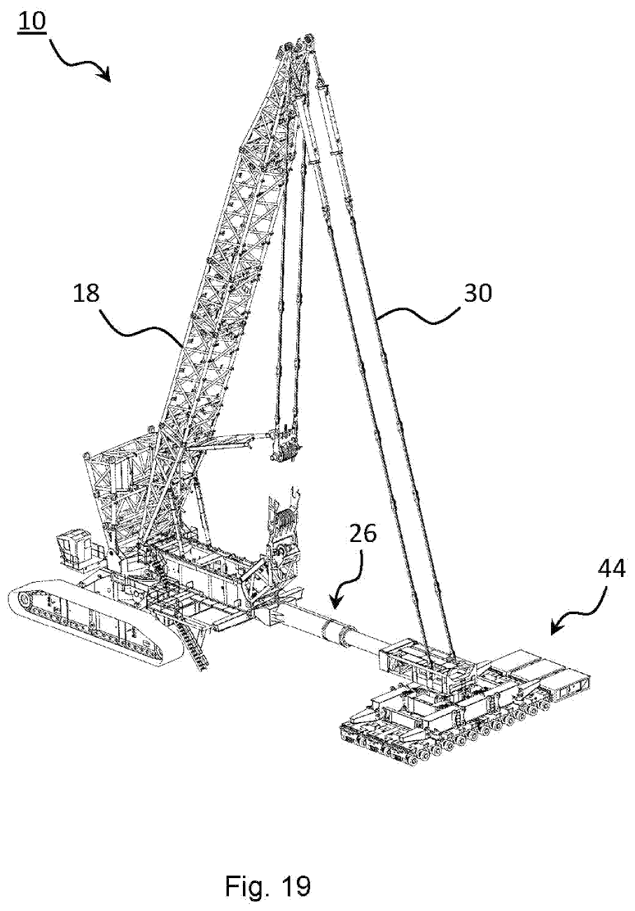

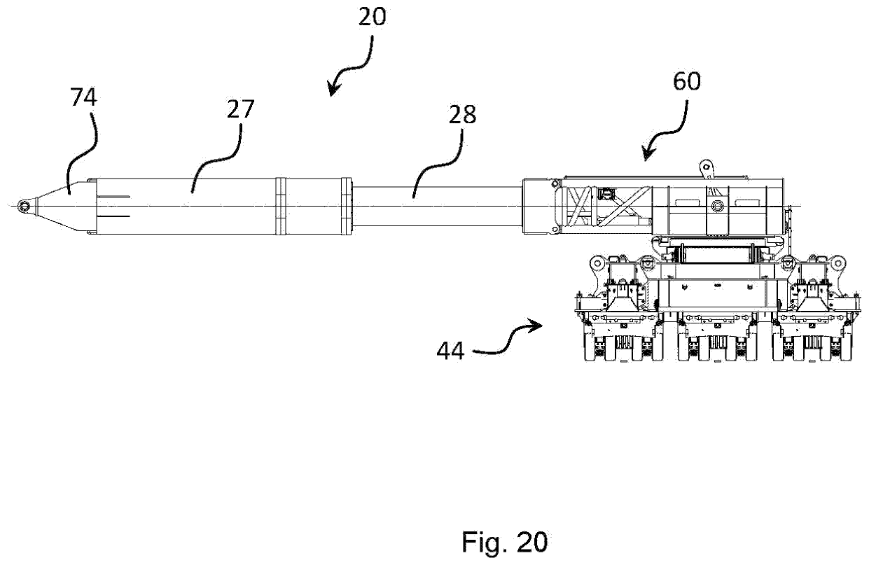

FIGS. 19 and 20 show a further embodiment of the guide 20 in a perspective overall view of the crane 10 (FIG. 19) and in a side view of the guide 20 (FIG. 20). Here, the guide 20 is telescopic and comprises a telescoping piece 26 with at least one outer section 27 and an inner section 28 slidably mounted therein. In the embodiment variant shown here, the telescoping piece 26 itself forms the guide 20 and comprises a linkage section, which is connected to the superstructure 14, and a connection section, which is connected to the ballast plate 42 (see FIG. 20). The outer section 27 is connected to the linkage section 74, while the inner section is connected to the connection device 60, which forms said connection section. Alternatively, the outer section 27 could be connected to the connection device 60 and the inner section 28 to the linkage section 74. By telescoping the sections 27, 28 in and out, the distance between the connection device 60 and the superstructure 14 and thus the ballast radius can be changed and continuously adjusted. More than two sections 27, 28 can be provided.

The connection device 60 can be configured according to the first, second or fourth exemplary embodiment. It is also conceivable that a pivot part 24 according to the third exemplary embodiment is located at the end of the inner section 28 and a connection device 60 with one or more adapter elements 80 is provided.

Alternatively, the telescoping piece 26 can form only one of several interconnectable pieces of the guide 20. The latter may additionally comprise a linkage piece 21 and/or one or more intermediate pieces 22. In particular, it may be possible to remove the telescoping piece 26 if necessary and use the guide 20 without the telescoping piece 26.

It is conceivable that the maximum stroke of the telescoping piece 26 represents the length of an intermediate piece 22 that is also present, so that the original length gradation of the entire guide 20 is essentially retained when the continuously telescoping telescoping piece 26 is used as required. However, operation in the not fully extended state is also possible and monitored by the crane control 90

The guide 20 may generally have a modular structure and comprise several modules or pieces that can be optionally connected to one another (e.g. one or more of linkage piece 21, intermediate piece 22, head piece or connection device 60, pivot part 24, telescopic piece 26).

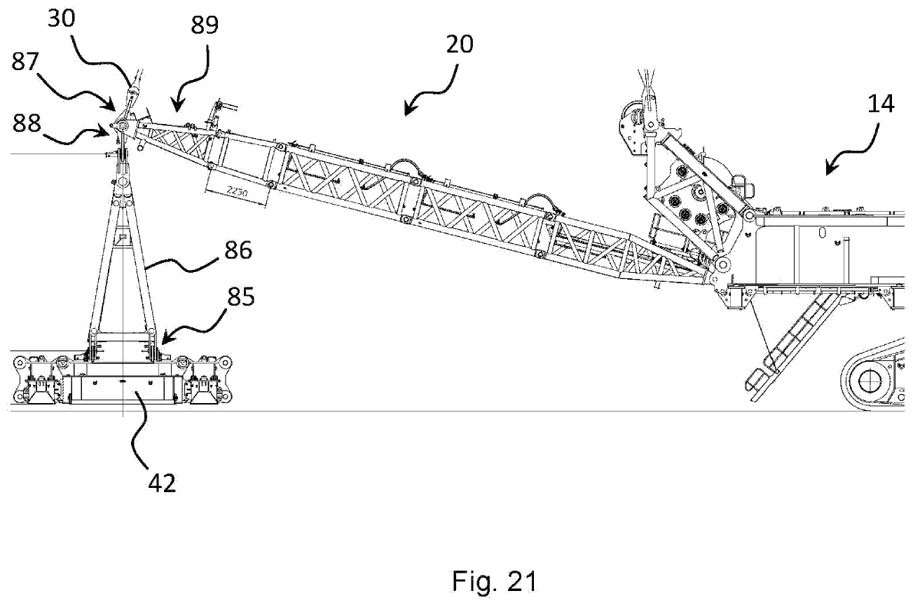

In the event that the lifting task does not require a movable ballast, the derrick ballast 40 can be configured so that it can also be used as a suspended ballast. For this purpose, the crane 10 can comprise additional bracing blocks 86, which can be mounted on the ballast plate 42 if required. First and second connecting means 87, 88 are provided for this purpose, via which a connection to the ballast bracing 30 can be established. The first connecting means 87 replace the connecting means 34 on the guide 20 or on the ballast plate 42. An example of such an embodiment is shown in FIG. 21, where two bracing blocks 86 are bolted to the ballast plate 42 via third connecting means 85. The first connecting means 87 connect the guide 20 in particular to the ballast bracing 30 in an articulated manner, while the second connecting means 88 connect the bracing blocks 86 in particular to the guide 20 in an articulated manner and are located at the upper end of the bracing blocks 86, which have an essentially triangular shape when viewed from the side.

In this case, the ballast plate 42 can be removed from the ballast wagon 44 and placed on the ground, whereupon the bracing blocks 86 are mounted and the ballast bracing 30 is connected to the first connecting means 87 of the bracing blocks 86.

The suspended ballast could be used without guide 20, wherein it is only held by the ballast bracing 30 and the latter is oriented vertically (i.e. the suspended ballast is located below the free end of the derrick boom 18). Alternatively, the suspended ballast with attached guide 20 could be used. For this purpose, a special head piece 89 could be fitted or installed in the guide 20 (see FIG. 21), which is connected in particular to the upper ends of the bracing blocks 86. This does not have a rigid connection with the bracing blocks 86, but an articulated or linked connection. This articulated connection may comprise the second connecting means 88. Such a head piece 89 thus creates an articulated connection between the ballast bracing 30, the guide 20 and the bracing blocks 86. As a result, the suspended ballast can be used together with the guide 20, thereby achieving a larger ballast radius.

The use of one or more SPMT 50 as a ballast wagon 44 generally offers several advantages:
SPMT have a high load-bearing capacity (e.g. >1000 t);
SPMTs are often already available to the user;
SPMT are tried and tested systems;
The SPMT can be controlled by crane 10 (e.g. steering pole shift, travel, emergency stop, support type, lifting/lowering, etc.).

To control the SPMT 50, the crane control 90 is connected to the drive control 54 of the SPMT 50 via a control connection so that the crane-derrick ballast combination can be controlled via the crane control 90. Both the crane 10 and the SPMT 50 have suitable interfaces for this purpose.

The control connection of the SPMT 50 covers one or more (preferably all) of the following areas and applications:
emergency stop: connection of the emergency stop circuits of crane 10 and SPMT 50;
force limitation;
moment limitation;
force compensation: determine and counteract the resulting forces;
moment compensation: identify emerging moments and counteract them;
steering modes: towing, parallel travel, circular travel, rotary travel and/or longitudinal travel;
drive: determine the required drive force;
levelling: compensate for slight inclines or declines in the terrain using a corresponding SPMT axle levelling system.

If a movement stop is triggered by a force limitation (entry into a second force range for one or more first or second actuators 1, 2 or for one or more force measuring bolts 3), an error message is preferably output to a crane monitor, which describes the error status in detail. The crane monitor can be located in a superstructure driver's cab and/or on a mobile device such as a tablet or a mobile control unit.

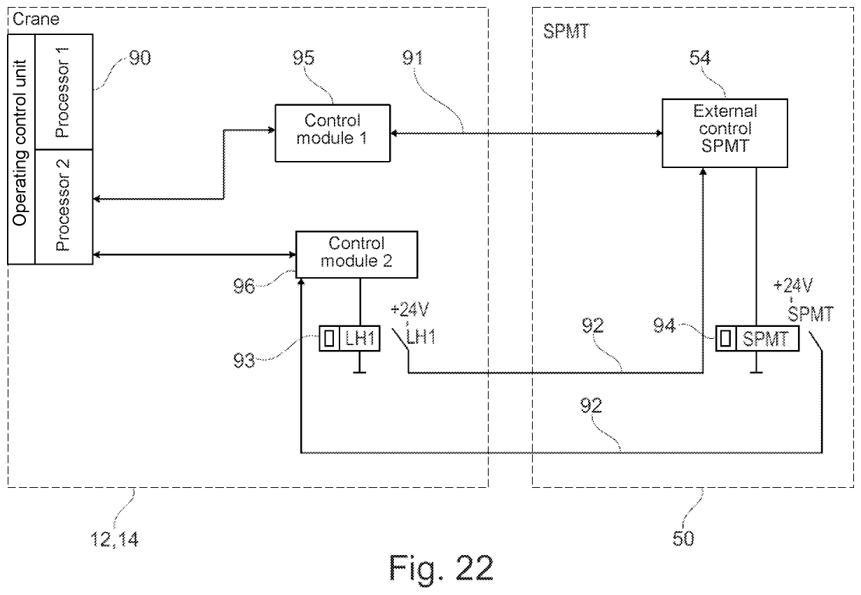

In the following, a preferred exemplary embodiment of the control system connection of the drive control 54 of the SPMT 50 to the crane control 90 of the crane 10 is described with reference to FIG. 22.

The control connection from crane 10 to SPMT 50 (or, if several SPMT 50 are used, to the SPMT network) is realized via a first data connection 91 in the form of a CAN bus. In addition to the security mechanisms of the CAN protocol, the data to be transmitted at the application level is preferably secured by means of a “live bit”. In this case, the crane control 90 cyclically sends a variable value to the SPMT 50, which the SPMT (or the drive control 54) must send back within a defined time. If the retransmission is not correct, all movements are stopped and the crane operator is notified of the inconsistent data connection, e.g. by means of an error message.

All safety-related functions such as motor ON/OFF, steering or driving are executed in two channels via the CAN bus connection and in each case via a separate safety relay contact of a crane-side safety switching device 93. The safety relay instructs the receiver (i.e. the SPMT 50) to accept the command from the CAN bus 91 (diverse execution, in both directions). Safety-relevant information from the SPMT 50 to the crane 10, such as “all steering angles in position”, is also executed by separate safety relay contacts of an SPMT-side safety switching device 94. The data connections via the safety switching devices 93, 94 form a second data connection 92 existing in parallel to the CAN bus 91. The safety switching devices 93, 94 are used for the safety-related interruption of a safety circuit. In particular, the safety relay contacts installed in the safety switching device 93, 94 are redundant and positively driven.

If the connection between crane control 90 and drive control 54 of the SPMT 50 is established via the control line, the crane control 90 takes over most, in particular all relevant control-related calculations and the SPMT 50 carries out the required requests. In this operating state, it is no longer possible for the SPMT 50 or the drive control 54 to carry out movements independently without releases from the crane control 90. For this purpose, it may be necessary to unplug an existing input unit of the SPMT 50 and replace it with a connection unit to the crane 10.

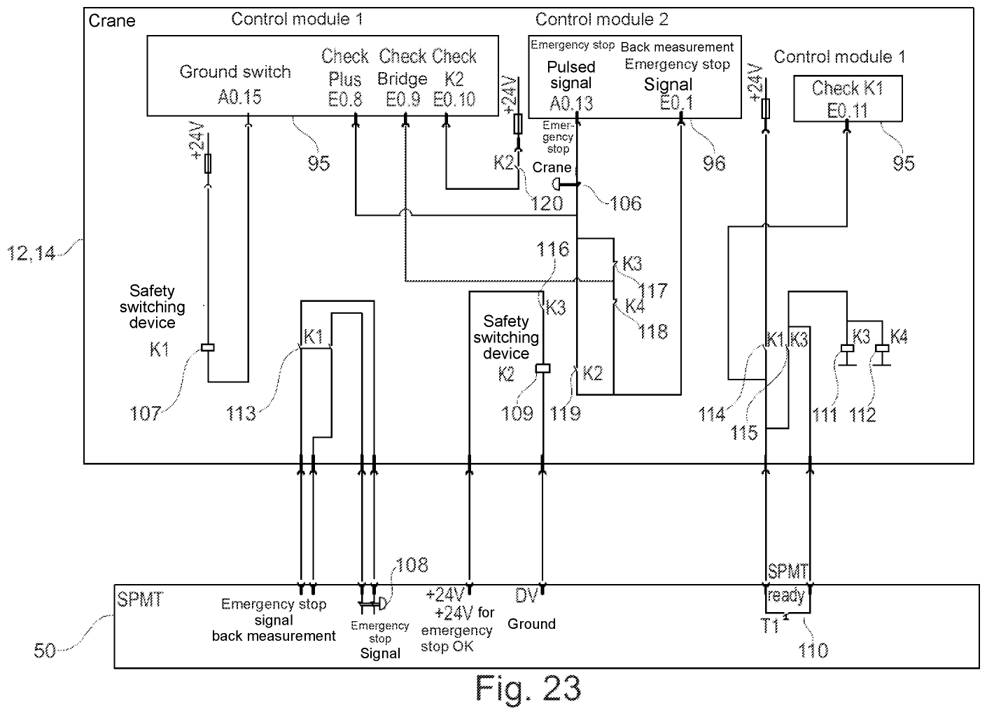

In the following, FIG. 23 illustrates an example of an implementation of an emergency stop function on the crane 10. All safety switching devices, switching relays and their switching contacts illustrated in FIG. 23 are shown in a de-energized state. If the safety switching devices are supplied with power, the switching states of the contacts shown change to the actuated state. If current is applied to a relay (e.g. relay K1), the switching state of all contacts “K1” 107, 113, 114 changes. In the example “K3” there are two normally open contacts 115, 116 and one normally closed contact 117.

The control modules 95, 96 shown in FIG. 23 correspond in particular to the control modules 95, 96 of the crane 10 of FIG. 22.

Both the crane 10 and the SPMT 50 each comprise an emergency stop switch (see FIG. 23: crane emergency stop switch: 106; SPMT emergency stop switch: 108). During crane operation with SPMT 50, actuation of any emergency stop switch on the crane 10 or the SPMT 50 leads to an emergency stop of both devices. As the SPMT 50 has a self-contained emergency stop chain, the emergency stop chains of both devices must be linked to each other via safety switching devices.

To couple the two emergency stop chains together, the following sequence in particular must be observed:
1. No emergency stop switch 106 on crane 10 may be actuated.
2. The control system of the crane 10 must be started. The safety switching device 107 (K1) is now supplied with power by the crane 10. The safety switch contacts 113, 114 are closed.
3. No emergency stop switch 108 on the SPMT 50 may be actuated.
4. The SPMT 50 control unit must be started.
5. Selector switch 110 (T1) on the SPMT 50 must now be actuated. When selector switch 110 (T1) is actuated, the switching relays 111 (K3) and 112 (K4) are supplied with power. The switching contacts 115, 116 are closed. The switching contacts 117, 118 are opened and thus integrate the safety switching contact 119 into the emergency stop chain. The safety switching device 109 (K2) is supplied with power, the safety switching contacts 119, 120 are closed.
6. Both emergency stop chains are now linked together. The common emergency stop chain is active.
7. The safety switch contacts 114, 120 are used for line monitoring (function of the switches tested).

When any emergency stop switch 106 on the crane 10 is actuated, the emergency stop is triggered on the crane 10. The safety switching device 107 (K1) is de-energized and interrupts the emergency stop chain of the SPMT 50 by opening the safety switching contact 113. When any emergency stop switch 108 of the SPMT 50 is actuated, the emergency stop is triggered on the SPMT 50, the safety switching device 109 (K2) is de-energized and interrupts the emergency stop chain of the crane 10 by opening the safety switching contact 119.

The safety switching device 107 shown in FIG. 23 can correspond in particular to the crane-side safety switching device 93 shown in FIG. 22. The safety switching device 109 shown in FIG. 23 can correspond in particular to the SPMT-side safety switching device 94 shown in FIG. 22.

The various steering modes (e.g. towing, parallel travel, circular travel, longitudinal travel, rotational travel) are specified in particular by the crane control unit 90. Each wheel axle is set to the correct steering angle on the SPMT 50 by transferring the ballast radius and the superstructure rotation angle from the crane control unit 90 to the SPMT 50. The

SPMT 50 is preferably equipped with a hydraulic drive motor. The corresponding drive pressure on the hydraulic drive motor of the SPMT 50 is regulated by the crane control unit 90 for the various travel movements. The SPMT 50 sets the required drive pressure. This can be influenced by the following factors:
Inclination of the terrain;
Driving speed;
Applied load or mass of the derrick ballast 40;
Steering mode;
Ballast radius.

In a preferred embodiment, the inclination of the terrain is determined via a sensor system that detects the current ballast inclination by means of a sensor, for example a sensor on the ballast plate 42. If the SPMT 50 moves upwards on an inclination, the drive pressure is increased in comparison to travel on level ground to ensure a smooth travel movement. If the SPMT 50 moves downwards on an incline, the drive pressure is lowered in comparison to driving on level ground. As a result, the SPMT 50 or the ballast wagon 44 is slowed down, ensuring a smooth travel movement. The term “incline” can be understood to mean an angle of inclination of 1°, for example.

In a further embodiment, a device for axle leveling can be provided. Any inclinations of the ballast plate 42 in the transverse direction caused by uneven terrain are detected by a sensor, for example a sensor on the ballast plate 42, and transmitted to the crane control 90. This inclined position can be compensated for by means of axis leveling of the SPMT 50. For this purpose, a corresponding raise/lower command is sent to the SPMT 50. The wheel axles of the SPMT 50 can be divided into several axle groups, e.g. into a first (e.g. left) and a second (e.g. right) axle group. The raise/lower command is then preferably sent to the SPMT 50 for the relevant axle group, e.g. raise first axle group, lower first axle group, raise second axle group or lower second axle group. One of the axle groups can also be raised and the other axle group lowered at the same time. An additional safety relay contact is preferably switched in parallel, which gives the SPMT 50 the corresponding release for leveling.

It should be noted at this point that the aforementioned sensors on or on the ballast plate 42 may technically belong to the crane 10 and not to the SPMT 50.

### LIST OF REFERENCE CHARACTERS

1 first actuator
2 second actuator
3 force measuring bolt
10 crane
11 A-block
12 undercarriage
13 crawler carrier
14 superstructure
15 superstructure ballast
16 boom (main boom)
17 fallback support
18 derrick boom
19 derrick bracing
20 guide
21 linkage piece
22 intermediate piece
23 coupling part
24 head piece
25 intermediate piece
26 telescopic piece
27 section
28 section
29 pivot part
30 ballast bracing
32 pull cylinder
34 connecting means
40 derrick ballast
41 ballast element
42 ballast plate
44 ballast wagon
50 heavy-load transport device (SPMT)
52 connecting element
54 drive control
60 connection device
62 moveable element
64 bearing
66 pivot bearing
67 first bearing section
68 second bearing section
70 rocker arm
74 linkage section
80 adapter element
81 first adapter part
82 second adapter part
83 connecting element
84 bearing
85 third connecting means
86 bracing block
87 first connecting means
88 second connecting means
89 head piece
90 crane control
91 first data connection
92 second data connection
93 safety switching device
94 safety switching device
95 control module
96 control module
100 direction of travel Crane
106 crane emergency stop switch
107 safety switching device K1
108 emergency stop switch SPMT
109 safety switching device K2
110 selector switch T1
111 switching relay K3
112 switching relay K4
113 safety switching contacts of K1 (2x NO contact)
114 safety switching contacts of K1 (1x NO contact)
115 switching contact of K3 (1x NO contact)
116 switching contact of K3 (1x NO contact)
117 switching contact of K3 (1x NC contact)
118 switching contact of K4 (1x NC contact)
119 safety switching contacts of K2 (1x NO contact)
120 safety switching contacts of K2 (1x NO contact)
200 direction of travel ballast wagon

1. Crane, comprising a movable undercarriage, a superstructure rotatably mounted on the undercarriage, a boom connected to the superstructure in a luffable manner, a derrick boom pivotally connected to the superstructure, via which the boom is braced, a crane control, a guide connected to the superstructure, and a derrick ballast,
wherein the derrick ballast comprises a ballast plate for stacking ballast elements, which is connected to the derrick boom via a ballast bracing and to the superstructure via the guide, and a ballast wagon,
wherein the ballast wagon comprises a heavy-load transport device with its own drive and its own drive control,
wherein the guide is connected to the ballast plate or the ballast wagon via a connection device, wherein the connection device comprises a measuring device which is configured to detect a force counteracting a relative movement between the ballast wagon and the guide, and
wherein the crane control is connected to the drive control of the heavy-load transport device via a control connection and is configured to control and/or regulate the heavy-load transport device depending on the force detected by the measuring device.

2. Crane according to claim 1, wherein the guide is configured such that the force generated by the derrick ballast is divided into a first force transmitted by the guide and a second force transmitted by the ballast bracing, and wherein the measuring device is arranged outside structures of the guide and the ballast bracing transmitting the first force and the second force.

3. Crane according to claim 1, wherein the measuring device comprises a first actuator by means of which a longitudinal force counteracting the relative movement between the ballast wagon and the guide in a longitudinal direction of the guide can be detected, wherein the first actuator is configured to provide a rigid connection between the guide and the ballast wagon in the longitudinal direction in a first force range, in which the longitudinal force is less than a defined limit force, and the crane control is configured to control and/or regulate the heavy-load transport device depending on the detected longitudinal force in such a way that the longitudinal force is minimized.

4. Crane according to claim 3, wherein the first actuator is configured to yield to the relative movement between the guide and the ballast wagon in a second force range in which the longitudinal force exceeds the defined limit force, and wherein the measuring device comprises a first position sensor, by means of which a change in position of the ballast wagon relative to the guide, can be detected in the second force range and the crane control is configured to stop or limit a movement of the crane and/or of the ballast wagon in response to the change in position detected by the first position sensor.

5. Crane according to claim 1, wherein the measuring device comprises a second actuator by means of which a torque counteracting a rotational movement between ballast wagon and guide can be detected, wherein the second actuator is configured to provide a rotationally rigid connection between the guide and the ballast wagon in a first torque range, in which the torque is less than a defined limit torque, and the crane control is configured to control and/or regulate the heavy-load transport device depending on the detected longitudinal force in such a way that the torque is minimized.

6. Crane according to claim 5, wherein the second actuator is configured to yield to a relative rotation between the guide and the ballast wagon in a second moment range in which the torque exceeds the defined limit torque, wherein the measuring device comprises a second position sensor, by means of which a change in position of the ballast wagon relative to the guide can be detected in the second force range and the crane control is configured to stop or limit a movement of the crane and/or of the ballast wagon in response to a change in position detected by the second position sensor.

7. Crane according to claim 1, wherein the connection device is arranged between the guide and the ballast plate and comprises a coupling part rigidly connected to the guide.

8. Crane according to claim 7, wherein the connection device comprises a movable element which is connected to the ballast plate, is movably mounted relative to the coupling part in the longitudinal direction of the guide, and is arranged below a connector which connects the ballast bracing to the guide and is arranged on the guide or on the coupling part.

9. Crane according to claim 3, wherein the connection device comprises a coupling part rigidly connected to the guide and a movable element connected to the ballast plate and movably mounted relative to the coupling part in the longitudinal direction of the guide, wherein the movable element is arranged below a connector which connects the ballast bracing to the guide, the connector arranged on the guide or on the coupling part, wherein the first actuator is coupled to the movable clement and to the guide, wherein the first actuator is configured as a hydraulic cylinder which is configured to block a relative movement between the movable element and the coupling part up to the defined limit force.

10. Crane according to claim 9, wherein the connection device comprises a rotation device via which the ballast plate is connected to the guide so as to be rotatable about a vertical axis, wherein the rotation device comprises a pivot bearing which is arranged on the movable element.

11. Crane according to claim 10, wherein the pivot bearing comprises a first bearing part connected to the connection device, and a second bearing part connected to the ballast plate, wherein a second actuator is coupled to the movable clement with the first bearing part and to the ballast plate with the second bearing part, wherein the second actuator is configured as a hydraulic cylinder or motor which is configured to block a relative rotation between the first bearing part and the second bearing part up to a defined limit torque.

12. Crane according to claim 7, wherein the connection device comprises at least two pivotably mounted rocker arms, via which the connection device is movably connected to the ballast plate, wherein the rocker arms permit a movement of the ballast plate relative to the coupling part in the longitudinal direction of the guide and are connected directly to the ballast plate or to an intermediate piece connected to the ballast plate, wherein the rocker arms arc arranged below a connection between the ballast bracing and the guide and wherein the rocker arms are arranged on the guide or on the coupling part.

13. Crane according to claim 12, wherein a first actuator is coupled to a rocker arm of the rocker arms or an intermediate piece movable by means of the rocker arm and to the guide, wherein the first actuator is configured as a hydraulic cylinder which is configured to block a pivoting movement of the rocker arms up to the defined limit force.

14. Crane according to claim claim 12, wherein the connection device comprises a rotation device via which the ballast plate is connected to the guide rotatably about a vertical axis, wherein the rotation device is arranged on the coupling part or on an intermediate piece connecting the rocker arms to the ballast plate and comprises a pivot bearing with two bearing parts rotatable relative to one another, wherein the bearing parts are coupled directly or indirectly via a second actuator, which is configured to block relative rotation between the bearing parts up to the defined limit torque.

15. Crane according to claim claim 12, wherein the connection device comprises at least four rocker arms which are configured in such a way that they allow a rotation of the ballast plate relative to the coupling part, wherein the coupling part is coupled via at least one second actuator to at least one rocker arm of the rocker arms or an intermediate piece connecting the rocker arms to the ballast plate.

16. Crane according to claim 15, comprising at least two second actuators, which are each connected to the coupling part and to one of the rocker arms and simultaneously function as first actuators, wherein the second actuators are arranged in such a way that the second actuators are loaded differently when the ballast plate is rotated relative to the coupling part, and the crane control is configured to control and/or regulate the heavy-load transport device depending on the detected load difference.

17. Crane according to claim 3, wherein the connection device is arranged between the ballast plate and the heavy-load transport device and comprises at least one adapter element, which comprises a first adapter part connected to the ballast plate and a second adapter part movable relative to the first adapter part in the longitudinal direction of the guide, which is connected to the heavy-load transport device, wherein at least one first actuator, which is configured as a hydraulic cylinder, is coupled to the first and to the second adapter part and is configured to block a relative movement between the first adapter part and the second adapter parts up to the defined limit force.

18. Crane according to claim 17, comprising at least two adapter elements spaced apart in a direction transverse to a longitudinal axis of the guide and each having at least one first actuator, wherein the adapter elements are configured in such a way that the second adapter parts can be pivoted laterally relative to the respective first adapter parts, wherein the first actuators simultaneously function as second actuators and are arranged in such a way that the first actuators are loaded differently relative to the ballast plate when the ballast wagon is rotated, and the crane control is configured to control and/or regulate the heavy-load transport device depending on the detected load difference.

19. Crane according to claim 18, wherein the guide comprises a head piece with a coupling portion rigidly connected to a remaining structure of the guide and a pivot part connected to the ballast plate, wherein the pivot part comprises a first pivot element connected to the ballast plate and a second pivot element connected to the coupling portion, which are pivotably mounted relative to one another about a pivot axis extending parallel to the longitudinal axis of the guide and permit rotation of the ballast plate about the pivot axis, wherein the ballast bracing is connected directly to the ballast plate.

20. Crane according to claim 1, wherein the connection device is arranged between the guide and the ballast plate and comprises a coupling part rigidly connected to the guide, wherein the measuring device comprises at least one force measuring bolt, by means of which a longitudinal force counteracting a relative movement between the ballast wagon and the guide in the longitudinal direction of the guide can be detected, wherein the crane control is configured to control and/or regulate the heavy-load transport device depending on the detected longitudinal force in such a way that the longitudinal force is minimized.

21. Crane according to claim 20, wherein the connection device comprises a rotation device with two bearing parts rotatable relative to one another, via which the ballast plate is connected to the coupling part rotatably about a vertical axis, wherein the bearing parts are coupled to one another directly or indirectly via at least one second actuator, which is configured to block rotation between the bearing parts up to a defined limit torque.

22. Crane according to claim 20, wherein the coupling part is rigidly connected to the ballast plate and the measuring device comprises at least two force measuring bolts, which are arranged in such a way that the two force measuring bolts are loaded differently when the ballast plate is rotated relative to the guide, wherein the crane control is configured to control and/or regulate the heavy-load transport device depending on the detected load difference.

23. Crane according to claim 20, wherein the coupling part comprises a connector via which the ballast bracing is connected to the connection device, wherein the at least one force measuring bolt is part of a bolt connection of the coupling part to the ballast plate or to an intermediate piece connected to the ballast plate, the bolt connection located below the connector.

24. Crane according to claim 1, further comprising at least one rigging block and first and second connectors for connecting the ballast bracing in an articulated manner to the at least one rigging block and/or to the guide, and further comprising a third connector for mounting the at least one rigging block on the ballast plate, wherein the ballast plate can be removed from the ballast wagon and wherein the at least one rigging block and the ballast plate are configured in such a way that the derrick ballast can be used as a suspended ballast when the rigging block is mounted and separated from the ballast wagon.

25. Crane according to claim 1, wherein the guide is configured to be adjustable in length, wherein the guide comprises a linkage piece connected to the superstructure and at least one intermediate piece which can be detachably installed between the linkage piece and the connection device and/or comprises a telescopic piece with at least two sections mounted so as to be displaceable one inside the other.

26. Crane according to claim 1, wherein the ballast plate is placed on the ballast wagon, and is detachably connected thereto via connecting elements.

27. Crane according to claim 1, wherein the guide is mounted on the superstructure so as to be pivotable about a horizontal axis and/or wherein a horizontal distance between a center of gravity of the derrick ballast and an axis of rotation of the superstructure is greater than a horizontal distance between a tip of the derrick boom and the axis of rotation of the superstructure.

28. Crane according to claim 1, wherein the control connection comprises two separate data connections between the crane control and the drive control of the heavy-load transport device, wherein a first data connection comprises a data bus and/or a second data connection comprises at least one safety switching device with a safety relay contact.

29. Crane according to claim 28, wherein the control connection comprises two emergency stop signal chains with a first emergency stop switch arranged on the crane and a second emergency stop switch arranged on the heavy-load transport device, wherein the crane control is configured to stop all movements of the crane and the heavy-load transport device when one of the first emergency stop switch and the second emergency stop switch is actuated.

30. Crane according to claim 28, further comprising an inclination detection device with at least one sensor for detecting an inclination of the derrick ballast, wherein the crane control is arranged controlling and/or regulating the heavy-load transport device on the basis of the data provided by the inclination detection device in such a way that a current terrain inclination is compensated by increasing a drive pressure of the drive of the heavy-load transport device when a positive terrain inclination is detected and reducing it when a negative terrain inclination is detected.

31. Crane according to claim 30, further comprising at least one actuator arranged on the ballast wagon and/or on the ballast plate, by means of which the ballast plate and/or the ballast wagon can be raised or pivoted relative to the ground, wherein the crane control is configured to control and/or regulate the at least one actuator on the basis of the data provided by the inclination detection device in such a way that the ballast plate is held in a horizontal orientation.
